(19) United States
(12) Patent Application Publication
(10) Pub. No.: US 2004/0089125 A1
(43) Pub. Date: May 13, 2004

(54) Compound miter saw

(75) Inventors: Keith R. Schoene, St. Charles, MO (US); Jason E. Hill, University City, MO (US); Daniel A. Terpstra, Kirkwood, MO (US)

Correspondence Address: HOWREY SIMON ARNOLD & WHITE LLP, ATTEN. DOCKETING DEPT. (A), 750 BERING DRIVE, HOUSTON, TX, 77057, US

(73) Assignee: Emerson Electric Co., St. Louis, MO

(21) Appl. No.: 10/306,863

(22) Filed: Nov. 27, 2002

Related U.S. Application Data
(60) Provisional application No. 60/424,806, filed on Nov. 8, 2002.

(51) Int. Cl. B26D 1/14; B27B 5/00; B27B 5/18; B23D 19/00; B27B 27/06; B26D 5/00

(52) U.S. Cl. 83/471.3; 83/397

(57) ABSTRACT

A compound miter saw is described having a bevel lock and bevel index to facilitate setting and locking the blade of the miter saw at desired bevel angles. Also described is a compound miter saw having a miter lock and miter index to facilitate setting and locking of the blade of the miter saw at desired miter angles. An improved down stop is disclosed that facilitates the return of the miter saw to a desired depth of cut. The disclosed miter saw is described having an improved fence, improved dust collection system, and improved carry handles.

### CROSS-REFERENCE TO RELATED APPLICATIONS

This application claims benefit of co-pending U.S. Provisional Application Serial No. 60/424,806, filed Nov. 8, 2002, entitled “Compound Miter Saw” by Keith R. Schoene, Jason E. Hill, and Daniel A. Terpstra, having attorney docket number 10872.0311.PZUS00, incorporated herein in its entirety by reference.

### BACKGROUND OF THE INVENTION

1. Field of the Invention

The invention relates to an improved miter saw apparatus. More particularly, this invention relates to a compound miter saw having improved locking and indexing mechanisms to facilitate the use of the miter saw for cutting at given miter and bevel angles. The invention also includes a depth gage that memorizes a given depth of cut upon removal from the index position. The invention further includes an improved sliding fence for holding a workpiece on the miter saw, improved components for the dust collection system for a miter saw, and improved carry handles for a miter saw.

2. Description of the Related Art

Miter and bevel cutting of wood, metals, and plastics is required in a variety of industries. In the construction industry, for example, moldings, door frames, window frames, chair rail and the like must be miter cut at corners. In addition to the diagonal or miter cut, a combined miter/bevel cut is required in certain instances for the proper fitting of cut parts. As will be appreciated, residential construction requires a relatively large number of such cuts.

Compound miter saws which have incorporated miter and bevel cutting features have been commercially successful. Some examples of prior art miter saws include U.S. Pat. No. 5,181,448 to Terpstra disclosing a miter saw having an improved supporting fence; U.S. Pat. No. 5,623,860 to Schoene, Terpstra, Brundage, and Tomiser disclosing a compound miter saw with an adjustable/by-passable bevel stop; U.S. Pat. No. 5,042,348 to Brundage disclosing a compound miter saw having a selectively rotatably table mounted on a supporting frame, and including an improved fence; U.S. Pat. No. 4,011,782 disclosing a miter saw pivotally mounted between an upper at-rest position and a lower operational position; U.S. Pat. No. 4,452,117 disclosing a miter saw mounted for movement on a pair of spaced parallel guide rods supported by a frame, together with spaced work supporting fences which retain their position while a miter table is selectably moved; U.S. Pat. No. 4,581,966 in which a powered miter saw has a swinging blade guard that covers an exposed segment of the saw blade when the saw is in an at rest position; and U.S. Pat. No. 4,638,700 in which a portable miter saw has a mechanism interlocked with the table for saw blade clearance gap in the work supporting fence.

The present invention relates to compound miter saws of the aforementioned type which have been further improved and are disclosed herein. For instance, bevel locks generally are used to lock the blade of a miter saw at a given bevel angle. Prior art bevel locks are generally operable from the back of the miter saw, which may be awkward for an operator to adjust. Thus, there is a need for a bevel lock which is operable from the front of the miter saw such that the operator may adjust the bevel angle without moving to the back of the miter saw. Additionally, some prior art bevel locks rely on the repeated tightening of mechanical components to lock the miter saw at a given bevel angle. Over time, this may cause wear of the components of the bevel locking mechanism. It is desirable that the bevel lock mechanism not necessarily rely on repeatedly over-tightening of mechanical components to lock the blade in place.

A bevel index facilitates an operator's setting the miter saw to cut at a given bevel angle. Again, some prior art bevel index mechanisms are operable from the back of the miter saw. As stated above, this may be awkward for an operator. Thus, there is a need for a bevel index which is operable from the front of the miter saw such that the operator may set the miter saw to a predetermined bevel angle. Further, as this bevel index may not be useful in some situations, it is desirable that the bevel index may be easily disengaged.

A miter lock mechanism is generally used to lock the blade at a given miter angle as described more fully within. It is desirable that the miter lock be equally useable by both a left and right-handed operator. It is desirable that the miter lock have an adjustable clamping force to lock the table to the base.

As more fully described herein, a miter index mechanism facilitates the miter saw being set at predetermined miter angles. Further, it is desirable that the miter index be operable from the front of the miter saw. Further, as this miter index may not be useful in some situations, it is desirable that the miter index may be easily disengaged to allow for fine tuning of miter angles near index points.

Prior art downstops may generally be used to set the miter saw at a given depth of cut. However, in some instances, once the down stop is removed (i.e. to perform a full cut), it may be relatively difficult to return to the give depth of cut. Thus, there is a need for a down stop which will “memorize” a given depth of cut and, after disengagement and subsequent re-engagement, be capable of quickly returning to that given depth of cut.

Miter saw fences are generally used to assist in securing a workpiece in the proper position on a miter saw to perform a given cut. Some prior art miter saw fences consisted of a stationary and movable portion of fence. Prior art miter movable fences may not generally be easily removable from the table. Thus, there is a need for a movable fence for a miter saw that is both sturdy when in place, but can be easily and quickly removed from the miter saw.

Finally, it is common for miter saws to utilize dust collection systems in which dust is collected into a dust bag. An improved dust bag which is sturdily attached to the miter saw is desirable.

Thus, it is desirable to produce a miter saw which can be more quickly, more easily, and more accurately set to produce predetermined bevel angles and miter angles than is available in the prior art. For the foregoing reasons, there is a need for a movable fence that is capable of securely affixing a workpiece to the miter saw while still being easily removable. Further, there is a need for an improved depth stop and an improved dust bag for a miter saw as described above. The claimed invention is directed at overcoming, or at least minimizing, disadvantages of the prior art.

### SUMMARY OF THE INVENTION

The invention relates to a miter saw. In some embodiments, a bevel lock for a miter saw is described having a bevel lock lever positional to a first and a second position of the pivot, and a lever arm functionally associated with the bevel lock lever such that when the bevel lock lever is in the first position, the pivot is free to rotate about the table hub, and when the bevel lock lever is in the second position, the table hub is locked to the pivot about the table hub with the blade forming a given bevel angle with the table.

In some embodiments, a bevel index for a miter saw is described having a bevel index housing functionally associated with the table of the miter saw, and a bevel index pin axially movable within a pin housing which is functionally associated with the bevel index housing such that the bevel index pin is engageable with one of a plurality of predetermined index stops in the pivot to set blade of the miter saw at a predetermined bevel angle with respect to the table.

Also described are embodiments of a miter index for a miter saw. In some embodiments, the miter index includes a miter index actuator functionally associated with the table, a miter index pin axially movable within the table such that the miter index pin is engageable with one of a plurality of predetermined miter index stops in the base to set the miter saw at a predetermined miter angle, and a connecting link to connect the miter actuator to the miter index pin.

Also described is a miter lock having a miter lock actuator functionally associated with table of the miter saw, and a miter lock pin axially movable within the table such that the miter lock pin is engageable with the base to lock the miter saw at a predetermined miter angle.

A down stop for use with a miter saw is also described having a stop mountable to the upper housing, a flange bushing adjustably mountable to an upper pivot on the table, and an eccentric disengageably mounted to the flange bushing by a knob, the eccentric adapted to contact the stop when the blade is lowered to a desired depth of cut.

In some embodiments, a dust collector is described for a miter saw having a bag having a front, a rear, and a flexible neck, and a framework supporting the front and the rear of the bag, the flexible neck being attachable to a dust chute on the upper housing.

In some embodiments, a sliding fence for use with a miter saw is described having a tongue slidably attachable into a groove on a lower fence on the base, and a rib acting in conjunction with a retaining screw on the lower fence to secure the tongue of the sliding fence within the groove to allow sliding movement of the fence, the rib having an opening such that when the opening is aligned with the retaining screw, the sliding fence may be removed.

In some embodiments, a carry handle for use in conjunction with a miter saw is described in which at least one carry handle is integrally formed into the base at a given angle.

### BRIEF DESCRIPTION OF THE DRAWINGS

FIG. 1 is a front perspective view of a prior art miter saw with the blade in the up position.

FIG. 2 is a perspective view of a prior art miter saw of FIG. 1 in the lowered (cutting) position.

FIG. 3 is a top view of a user using the prior art miter saw of FIG. 1.

FIG. 4A is a side view of a user using the prior art miter saw of FIG. 1.

FIG. 4B is a rear view of the prior art miter saw of FIG. 1.

FIG. 5 shows embodiments various aspects of an improved miter saw disclosed herein.

FIG. 6A shows the front view of an embodiment of a bevel lock for a miter saw of the present invention.

FIG. 6B shows a back view of the embodiment of FIG. 6A.

FIG. 7 shows the embodiment of FIG. 6A with the bevel lock in the locked position.

FIG. 8 shows a cut-away view of the embodiment of FIG. 6A.

FIG. 9 shows the front view of the embodiment of FIG. 6A in the unlocked position.

FIG. 10 shows the back view of the embodiment of FIG. 6A in the unlocked position.

FIG. 11A shows another embodiment of a bevel lock of the present invention.

FIG. 11B shows another embodiment of a bevel lock of the present invention.

FIG. 12 shows another embodiment of the bevel lock of the present invention being a lock knob.

FIG. 13 shows another embodiment of the bevel lock of the present invention having a lock knob.

FIGS. 14A-C show a perspective, exploded, locked, and unlocked figures for another embodiment of the present invention.

FIG. 15 shows a cutaway view of a bevel index of one embodiment of the present invention.

FIG. 16 shows an end view of the embodiment of FIG. 15.

FIGS. 17A and B show the embodiment of FIG. 15 with the roll pin in the deep product.

FIGS. 18A and B show the embodiment of FIG. 15 with the roll pin in the shallow pocket.

FIGS. 19A-C show the embodiment of FIG. 15 functionally associated with the table and pivot.

FIGS. 20-20E show another embodiment of a bevel index of the current invention.

FIG. 21 shows a miter index of one embodiment of the present invention in the locked position.

FIG. 22 shows a miter index of one embodiment of the present invention in an over-connected position.

FIG. 23 shows a miter index of one embodiment of the present invention in an over-centered position.

FIG. 24 shows a miter lock of one embodiment of the present invention in a locked position.

FIG. 25 shows one embodiment of the present invention in an unlocked position.

FIG. 26 shows a miter lock actuator such as a miter lock lever and a miter index actuator such as a thumb wheel of embodiments of the present invention in the locked position.

FIG. 27 shows a miter index actuator wheel and a miter lock actuator of one embodiment of the present invention with the miter lock lever in an unlocked position.

FIG. 28 shows a downstop of one embodiment of the present invention in an exploded view.

FIG. 29 shows a downstop of one embodiment of the present invention in which a stop is contacting an eccentric.

FIG. 30 shows a downstop of one embodiment of the present invention in which an accentric is pulled to disengage the key-way.

FIG. 31 shows a downstop of one embodiment of the present invention in a configuration which allows a full depth of cut.

FIG. 32 shows a downstop of one embodiment of the present invention in which the stop is aligned with a hole in the eccentric.

FIG. 33 shows one embodiment of the present invention in which the depth of cut is set to a height H1.

FIG. 34 shows one embodiment of the present invention in which the depth of cut is set to a height of H2.

FIGS. 35-38 show the sliding fence of one embodiment of the present invention.

FIGS. 39-42 show carry handles of one embodiment of the present invention.

While the invention is susceptible to various modifications and alternative forms, specific embodiments have been shown by way of example in the drawings and will be described in detail herein. However, it should be understood that the invention is not intended to be limited to the particular forms disclosed. Rather, the intention is to cover all modifications, equivalents and alternatives falling within the spirit and scope of the invention as defined by the appended claims.

### DESCRIPTION OF ILLUSTRATIVE EMBODIMENTS

The invention relates to an improved apparatus for cutting a workpiece at given miter and bevel angles with a miter saw. In some embodiments, a bevel lock is disclosed which is operable from the front of the miter saw and minimizes repeated over-tightening and/or under-tightening of mechanical components. A bevel index is disclosed which is operable from the front of the miter saw and is relatively easily adjustable. An ambidextrous miter index which is selectively disengageable is also disclosed, as is a miter lock operable from the front of the miter saw in which the clamping force may be adjusted. A down stop for a miter saw is disclosed that has the ability to memorize a given depth of cut. An improved fence for a miter saw, improved components for the dust collection system for the miter saw, and improved carry handles for the miter saw are also described.

Illustrative embodiments of the invention are described below as they might be employed in the cutting of a workpiece to given miter and bevel angles. In the interest of clarity, not all features of an actual implementation are described in this specification. It will of course be appreciated that in the development of any such actual embodiment, numerous implementation-specific decisions must be made to achieve the developers' specific goals which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments of the invention will become apparent from consideration of the following description and drawings.

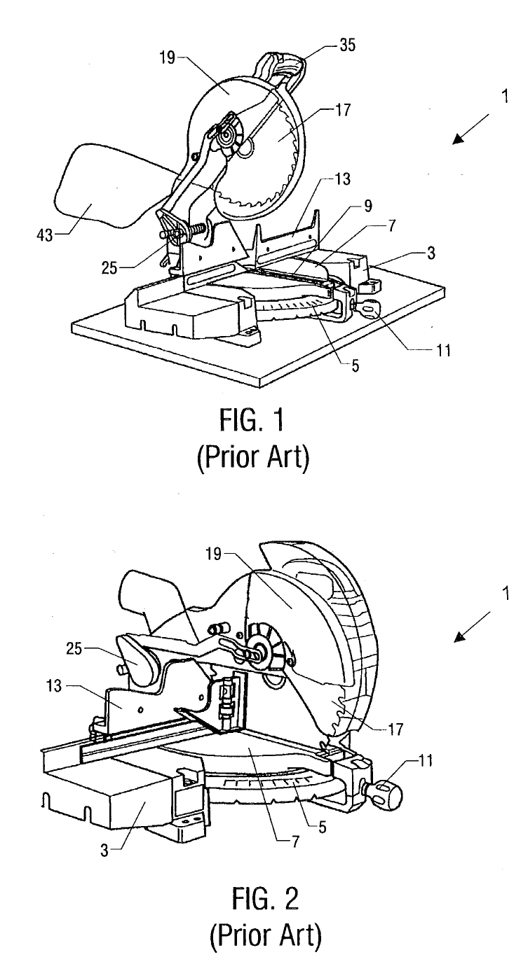

Before discussing the specific improvements of the present invention in compound miter saws or the like, reference is first made to FIGS. 1-4 of the drawings for an overview and description of the principal components of the compound miter saw, and the manner in which the components cooperate together to achieve the desired miter and/or bevel cuts in workpieces. As illustrated, the compound miter saw 1 includes a base or frame 3 having an arcuate miter scale 5 attached at an upper, front position thereof for ease of use and visibility by the user. A table 7 is selectively rotatably mounted on the base or frame 3 and is provided with a saw blade slot 9 therein. A miter lock handle 11 is constructed to selectively rotate the table 7 relative to the base or frame 3 in order to position the table 7 in the desired miter setting, as shown on the miter scale 5.

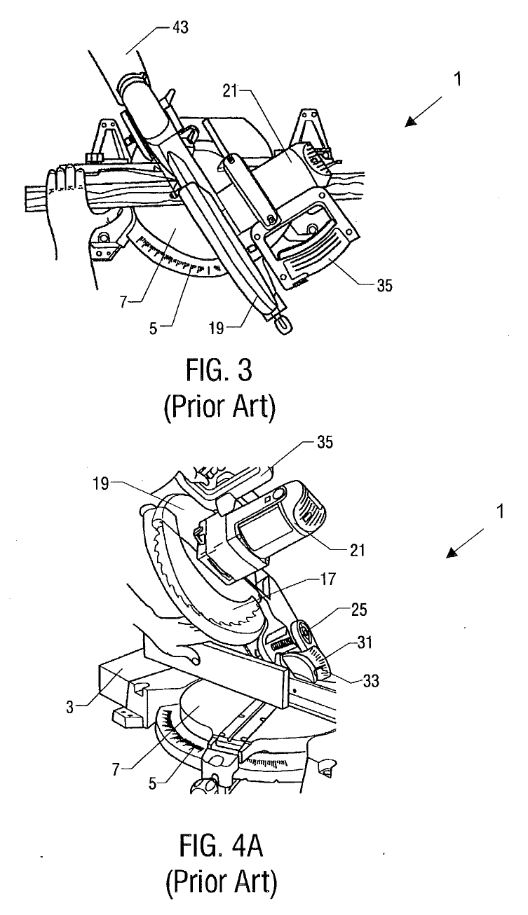

In order to hold and support workpieces, as shown in FIGS. 3 and in 4A, in accurate aligned and squared position in the compound miter saw 1, a work supporting fence 13 is provided. A miter saw blade 17 is rotatably mounted within the upper housing 19 and is power driven by an electric motor 21 (shown in FIG. 3) mounted to the upper housing 19. The upper housing 19 is pivotally mounted relative to the base or from 3 at pivot axis 29, through closed cylinders as described, e.g., in U.S. Pat. No. 4,934,233.

The miter cutting of a workpiece, by moving the table 7 via the miter lock hand 11, is best illustrated in FIGS. 1 and 3 of the drawings. The operator unlocks miter lock handle 11, rotates table 7 to the desired miter angle shown on the miter scale 5, and then locks the table 7 at the desired miter angle via lock handle 11.

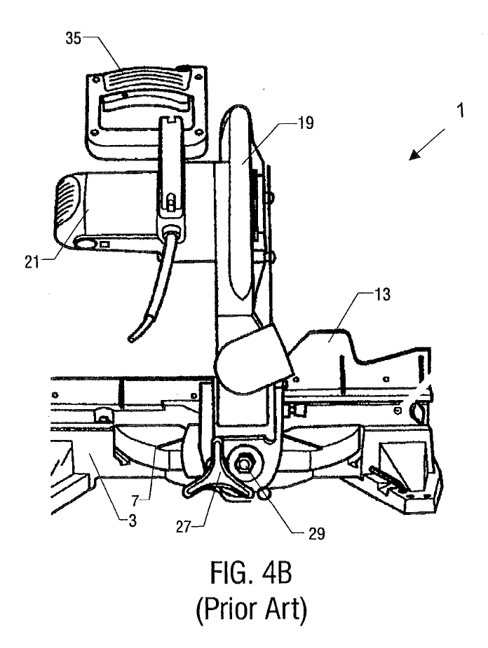

The compound miter saw 1 can also be utilized to make bevel cuts (i.e. angles from the vertical plane) in workpieces, as best shown in FIG. 4 of the drawings.

The bevel adjustment for the compound miter saw, as seen in FIGS. 4A and 4A of the drawings, includes a bevel lock handle 27 which may be loosened to allow the entire upper housing 19, including components associated therewith, to be pivotally moved along pivot axis 29, to the desired bevel angle, as determined by the bevel scale 31 and fixed pointer 33 on adjacent fixed and moving cylinders (as described in U.S. Pat. No. 4,934,233). For raising and lowering the miter saw blade 17 about the pivot axis 29, a miter saw handle 35 with associated trigger switch (not shown) that energizes the motor 21 is provided. The miter saw is compound, as the miter saw 1 is capable of making both miter and bevel cuts simultaneously.

For collecting dust and other debris generated from cut work pieces, a dust bag 43 (shown in FIG. 1) is attached to an exhaust outlet at the rear of the upper guard housing 19.

In light of the general understanding of the prior art compound miter saw 1 from the above description, embodiments of the present invention will now be described with reference to the accompanying figures.

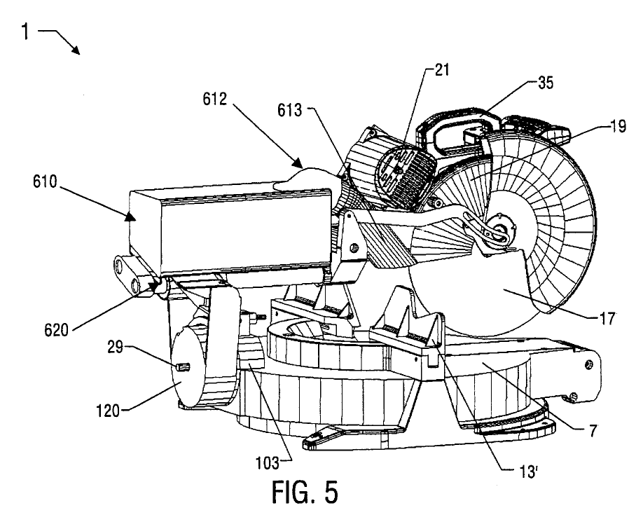

An improved miter saw 1 having components described hereinafter is shown in FIG. 5. A blade 17 is rotatably mounted on upper housing 19 and is driven by motor 21. Table 7 of the compound miter saw 1 further comprises a table hub 103 in this embodiment. A pivot 120 is pivotally attached to table hub 103 about pivot axis 29. Upper housing 19 is attached to the pivot 120. Further aspects of this improved miter saw 1 will be described in detail below.

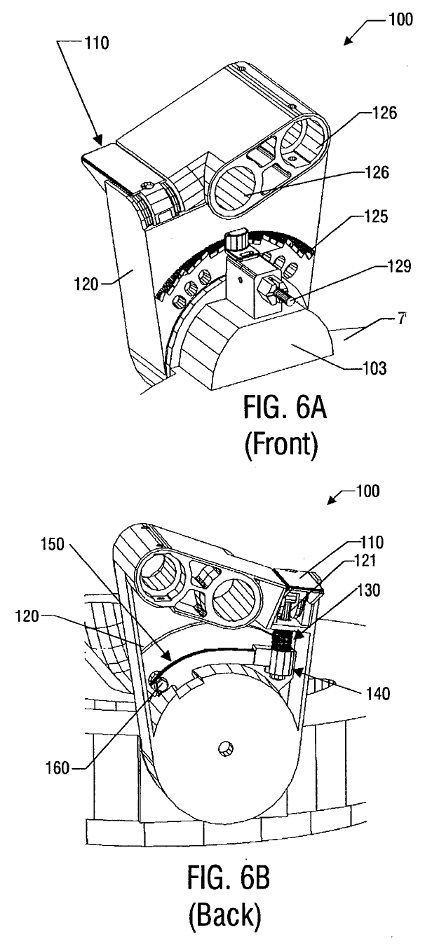

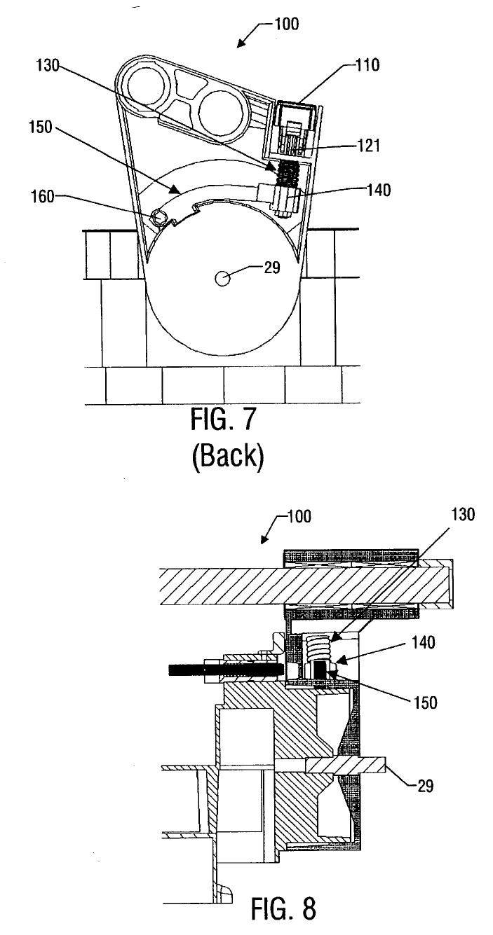

Now referring to FIGS. 6A-11A, an improved bevel lock 100 of one embodiment of the present invention is shown. This embodiment of the improved bevel lock 100 may be comprised of a bevel lock actuator such as a bevel lock lever 110 pivotally attached to pivot 120. The bevel lock lever 110 may have a cammed surface capable of supplying a downward force on other components, as described more fully hereinafter.

Pivot 120 may contain surface indicia 125 corresponding to bevel angles. Upper housing 19 of the compound miter saw and its associated components attached thereto (motor 21, handle 25 with trigger switch 27, and blade 17, e.g.) described above are not shown in FIGS. 6-11; however, upper housing 19 and its associated components are attached to pivot 120 via attachment cylinders 126 (or by any number of means known to one of ordinary skill in the art) such that the longitudinal axis of the upper housing 19 is parallel with pivot axis 29 (as shown in FIG. 5).

Bevel lock 100 may further include a biasing means such as a spring 130 functionally associated with the pivot 120 via a retaining means such as a spring retainer 140 Spring retainer 140 may circumscribe plunger pin 121. The plunger pin 121 in this embodiment may have two ends: one attached to the bevel lock lever 110, and one attached to an end of a base contact such as the lever arm 150.

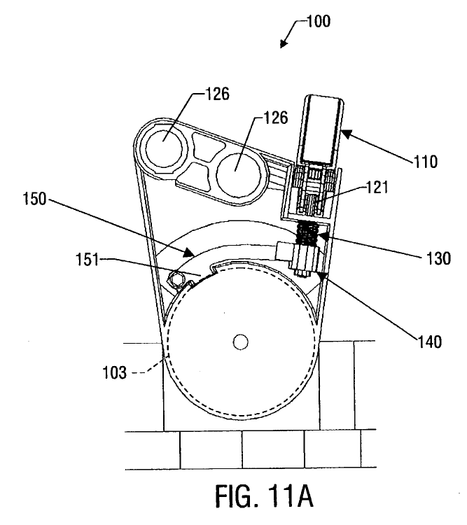

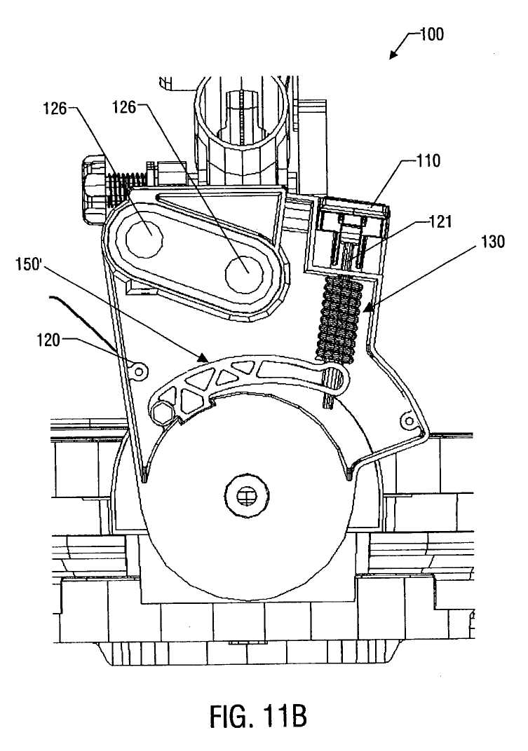

Another end of lever arm 150 may be pivotally attached to the pivot 120 by a resisting screw 160, for example. Any other type of retainer known to one of ordinary skill in the art having benefit of this disclosure could similarly be utilized. Lever arm 150 may further comprise a protrusion or contacting surface 151 (shown in FIG. 11A) which contacts the table hub 103 when the bevel lock 100 is in its locked position.

The table 7 of the compound miter saw 1 described above further comprises a table hub 103 in this embodiment. Pivot 120 is pivotally attached to table 7 via the table hub 103 about pivot axis 29.

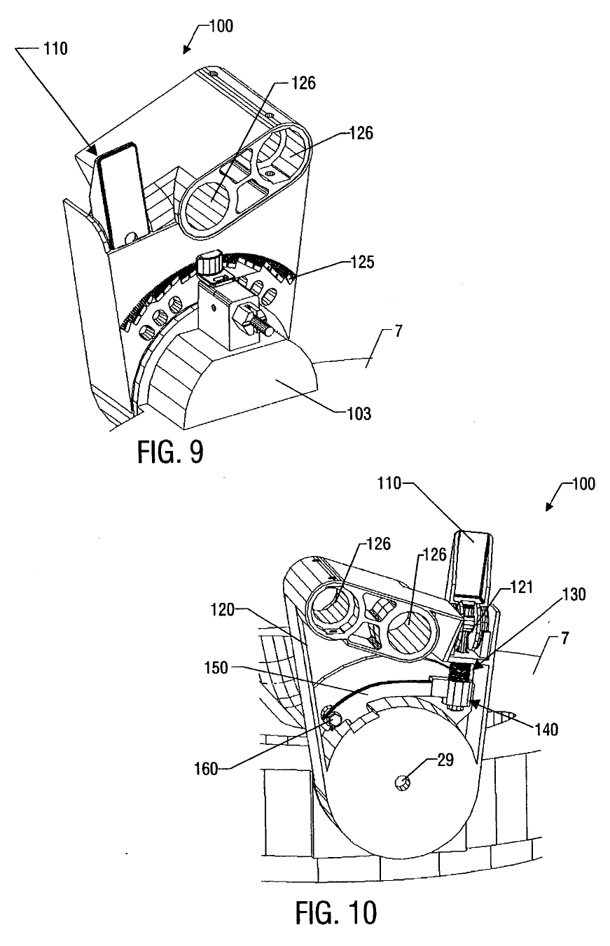

The bevel lock 100 is shown in an unlocked position in FIGS. 9, 10 and 11A. In this unlocked position, pivot 120 is free to rotate about its pivot axis 29 with respect to the table 7.

To set the compound miter saw to perform a bevel cut at a given bevel angle, an operator may pull upwardly on bevel lock lever 110. Once in the unlocked position, the operator may rotate the upper housing 19 and pivot 120 about pivot axis 29 to a desired bevel angle, as displayed via surface indicia 125, for example. When the bevel lock lever 110 is moved to the up or “unlocked” position, the plunger pin 121 applies an upward force onto spring retainer 140. This upward force releases the force being exerted onto one end of lever arm 150 which releases the force on the table hub 103 by the contacting surface 151 of the lever arm 150. This action thus unlocks the pivot 120 from the table hub 103.

This upward force also compresses spring 130. The spring 130 being in compression assists in keeping the bevel lock lever 110 in the up, “unlocked” position due to the over centered shape (cammed surface) of the non-free end of the bevel lock lever 110. This assists the user in rotating the upper housing 19 including blade 17 of the miter saw 1 a desired bevel angle without the operator having to hold the bevel lock lever 110 in the up “unlocked” position.

Once the upper housing 19 (with blade 17) and pivot 120 are positioned at the desired location with respect to the table 7 via table hub 103, the operator may apply a downward force on bevel lock lever 110. When the bevel lock lever 110 is in the down “locked” position (as shown in FIGS. 6A, 6B, and 7), the spring 130 exerts a downward force on the spring retainer 140. Further, the spring retainer 140 pushes downwardly on one end of th lever arm 150, which then rotates about retaining screw 160 such that its connecting surface 151 contacts table hub 103. This securely locks the pivot 120 to the table hub 103 at the desired position.

This embodiment of the bevel lock 100 can exert a relatively-consistent force to lock the upper housing 19 at a given bevel angle, due to the use of the spring 130 acting as the locking force. This prevents the operator from over tightening a locking mechanism, an action which can cause damage to the unit. This mechanism also prevents under-tightening, which can cause movement in the upper housing 19 during use.

Additionally when the bevel lock 100 is unlocked, the pivot assembly 120 retains a constant fit with the table hub 103. Thus, this bevel lock 100 minimizes movement of any of the mating parts as it is unlocked and locked. Prior art bevel lock mechanisms may rely on the bevel lock to pull mating parts tightly together to take up any looseness and clearance between mating parts before final locking is achieved. Some prior art mechanisms may allow the pivot/arm assemblies to sag or drop when unlocked. Further, when some of these prior art mechanisms are tightened, the clearance is pulled together which can cause the desired bevel angle to change. This can make accurate setting of the bevel angles more difficult.

Finally, as described above, a user may activate this embodiment of the bevel lock 100 from the front of the miter saw 1. Thus, the user is not required to reach around to the back of the unit to unlock and lock the bevel, an act which could be awkward and difficult while trying to hold the unit at a desired bevel angle.

FIG. 11B shows an embodiment of the present invention that is similar in structure and function as that embodiment shown in FIG. 11A. However, the base contact such as the lever arm 150 of this embodiment may be comprised of an integrally formed single piece, which may be cast, that replaces the lever arm 150 and spring retainer 140 of the embodiment shown in FIG. 11A. The embodiment in FIG. 11B thus has fewer parts and may be more easily assembled than the embodiment shown in FIG. 11A. The bevel lock actuator 110 of this embodiment may further comprise a journal that may rest within a bearing in the pivot 120. In this embodiment, one end of the plunger pin 120 contacts the journal of bevel lock actuator. The other end of the plunger pin 121 is attached to an end of the integral lever arm 150. FIG. 11B shows the embodiment of the present bevel lock in the closed position. In this position, the spring 130 applies a downward force on one end of integral lever 150. Integral lever arm 150 then rotates about retaining screw 160 such that its connecting surface 151 contacts table hub 103. This securely locks the pivot 120 to the table hub 103 at the desired position.

To unlock this embodiment of bevel lock 100, the operator may pull upwardly on bevel lock lever 110. Due to the eccentric nature of the journal, this upward force on the bevel lock lever 110 rotates the bevel lock lever within the bearing of the pivot 120, which in turn applies an upward force to plunger pin 121. This upward force on plunger pin 121 also compresses spring 130 and pulls upwardly on the integral lever arm 150. This, in turn, rotates the integral lever arm 150 about retaining screw 160 such that its connecting surface no longer contacts table hub 103. This action unlocks the pivot 120 from the table hub 103.

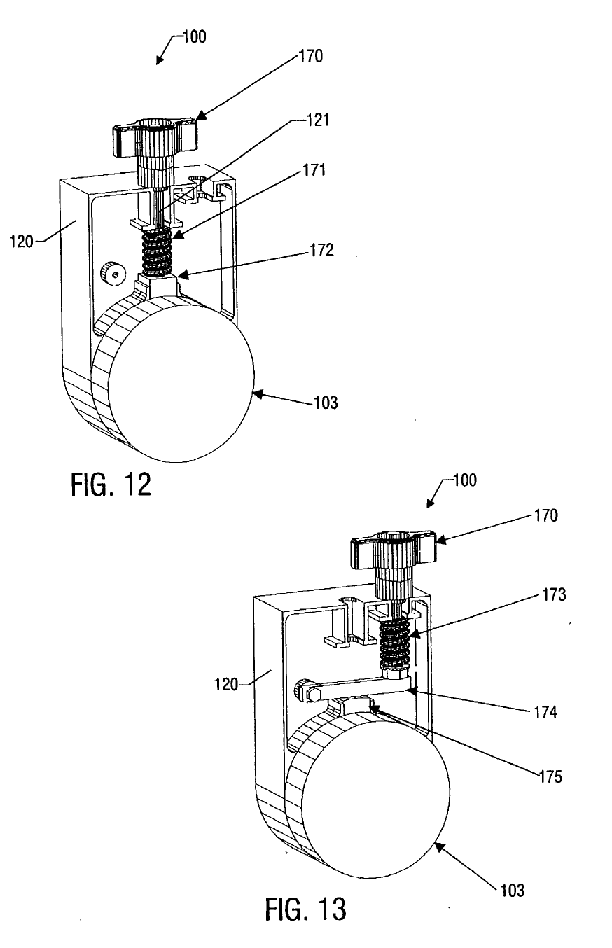

FIG. 12 shows an embodiment of the present bevel lock 100 similar to that shown in FIGS. 5-11B. The embodiment shown in FIG. 12 uses an actuator such as a cammed lock knob 170, spring 171, plunger pin 121, and base contact such as a plunger 172 to lock against the table hub 103. The cammed lock knob 170 may have a cammed surface which mates with another cammed surface on the unit. As the cammed lock knob 170 is rotated, the plunger pin 121, which is integrally connected to plunger 172, is forced upward. The clamping force of the spring 171 is overcome thus removing the clamping force from the table hub 103. This unlocks the pivot 120 from the table hub 103. When the knob 170 is released, the spring 171 can expand and thus exerts a downward force on the plunger 172. This downward force pushes the plunger 172 downward to contact table hub 103 to lock the pivot 120 in place.

FIG. 13 shows another embodiment of the present bevel lock 100. This embodiment comprises a cantilevered arm 174 to activate the base contact, such as a plunger 175, that locks the pivot 120 to the table hub 103. The actuator, such as the cammed lock knob 170, may have a cammed surface which mates with another cammed surface on the unit. As the cammed lock knob 170 is rotated, the plunger pin 121 is forced upward away from cantilevered arm 174. The spring 173 is compressed and the plunger 175 is allowed to move upwardly away from table hub 103. This unlocks the pivot 120 from the table hub 103. When the knob 170 is released, the spring 173 can expand and thus exerts a downward force on the free end of the cantilevered arm 174. This allows the cantilevered arm 174 to exert a downward force on plunger 175. This downward force pushes the plunger 175 downward to contact table hub 103 to lock the pivot 120 in place.

Although not shown, each of the bevel locks shown in FIGS. 5-13 can be used with either the twist-type knob or a cammed lever to activate the bevel lock mechanism 100, as would be known to one of ordinary skill in the art having benefit of this disclosure. For instance, the spring could be removed and a downward force may be applied via a screw motion on the know or a cammed motion on a lever.

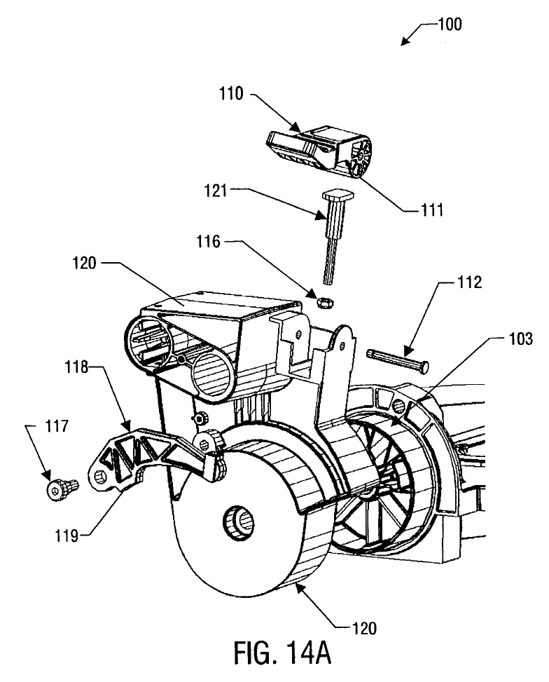

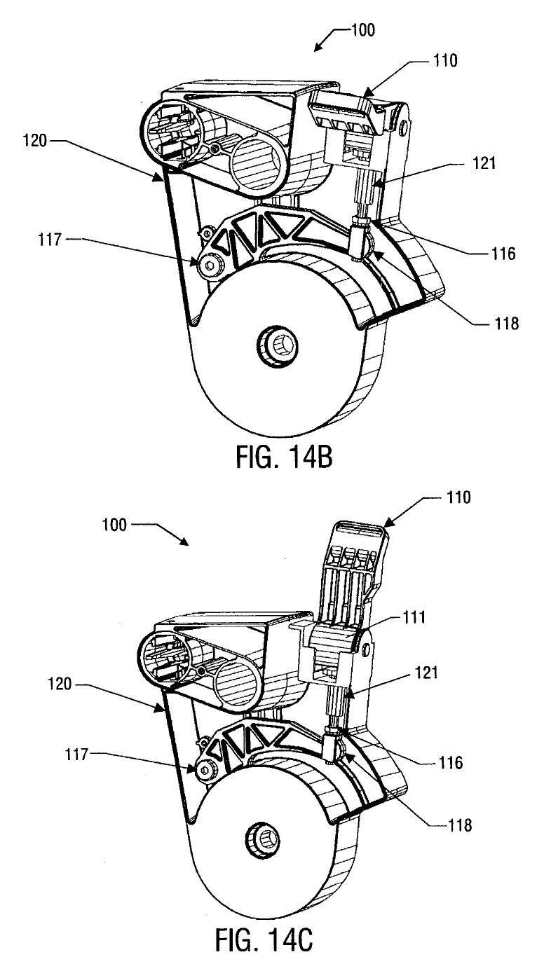

FIGS. 14A-C show another embodiment of a bevel lock mechanism 100. Bevel lock 100 comprises a bevel lock actuator such as a bevel lock lever 110 which may have a cammed surface 111. Referring to FIG. 14A, the bevel lock lever 110 is shown pivotally attached to the pivot 120 via a pin 112. The cammed surface 111 of bevel lock lever 110 contacts one end of a plunger pin 121 which may be surrounded by a lock nut 116. The plunger pin 121 protrudes through a locating hole in the pivot 120. The other of the plunger pin 121 contacts one end of a lever arm 118. A lock-nut 116 may be attached to the plunger pin 121 to allow for adjustment for setting the desired force on the lever arm 1 18 in operation. The other end of the lever arm 118 may be rotatably attached to the pivot 120 via shoulder bolt 1 17.

In operation, the pivot 120 (and thus the blade 17, not shown) may be locked to the table 7 via the table hub 103 at a given bevel angle as follows. The user applies a downward force on the lever end of bevel lock lever 110. As the lever end of the bevel lock lever 110 is depressed, the entire bevel lock lever 110 including cammed surface 11 1 rotates about pin 1 12. The cammed surface 11 1 on the bevel lock lever 1 10 applies a downward force on the plunger pin 121 and the lock nut 116 downwardly toward one end of the lever arm 1 18. The lock nut 1 16 then pushes one end of the lever arm 118 down causing the lever arm 118 to rotate about the shoulder bolt 117. This action, in turn, causes the contact surface 119 on the pivot arm 118 to contact the table hub 103 thus preventing the pivot 120 from rotating. Thus, the blade is locked at a given bevel angle. The bevel lock 100 is shown in this locked position in FIG. 14B.

To unlock the pivot 120 from the table hub 103, the operator applies an upward force on the lever end of bevel lock lever 110. This causes the entire bevel lock lever 110 to rotate about pin 1 12, causing the cammed surface 111 to release the force being applied to the plunger pin 121. As the force from the plunger pin 121 is released, the force applied to the free end of the lever arm 118 is also released, thereby releasing the force applied from the contact surface 1 19 of lever arm 1 18 to the table 7 via the table hub 103. With no force to ensure contact between the contact surface 119 and the hub table 103, the pivot 120 is free to rotate, or is “unlocked” from the table hub 103. The pivot 120, and thus the entire upper housing 19 including the blade 17, are therefor free to be rotated to a new bevel angle. The bevel lock 100 is shown in this unlocked position in FIG. 14C.

Often, when using a miter saw, it is desired to use standard bevel angle settings for given operations. For instance, bevels angles of 45°, 33⅞°, 22½° (each left and right), as well as 0° have uses common to various miter saw operations, such as cutting crown molding.

Thus, one embodiment of the present invention includes a bevel index 200 which allows a user to select from any given preset bevel angle settings as further described below. It should be noted that the bevel index may be utilized with the embodiments of the bevel locks 100 described above. For instance, the bevel lock could be unlocked, the bevel index used to set the miter saw to the desired bevel angle, and the bevel lock used to lock the miter saw blade at that desired bevel angle.

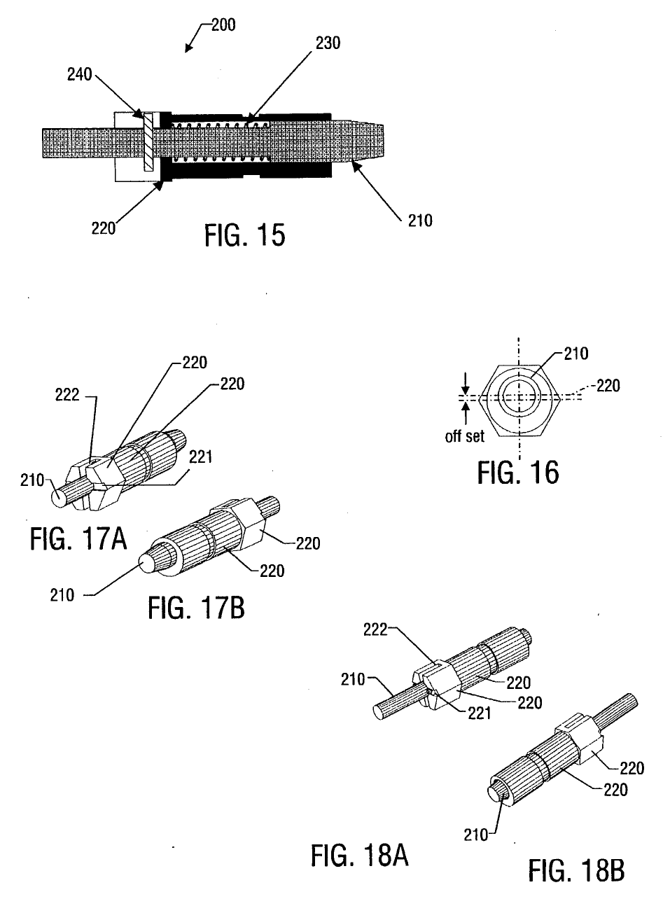

Referring now to FIGS. 15-19C, a bevel index 200 of one embodiment of the present invention is shown. The bevel index 200 may be located on the miter saw so that the bevel index 200 may be easily seen and operated from the front of the miter saw 1. The bevel index 200 of this embodiment comprises a bevel index pin 210, an index housing 220, a spring 230, and roll pin 240. The spring 230 circumscribes bevel index pin 210. Spring 230 is functionally associated with the housing 220 and may rest within housing 220. Bevel index pin 210 may be tapered on one end, and may have a stop, such as a roll pin 240, perpendicularly attached to the other end of bevel index pin 210 as shown in FIG. 15.

One end of the housing 220 comprises slots 221 and 222. In this embodiment, the slots are perpendicular, although this perpendicular orientation is not necessary. One slot 222 is deeper (i.e. longer along the axis of the bevel index pin 210 than the other shallow slot 221.

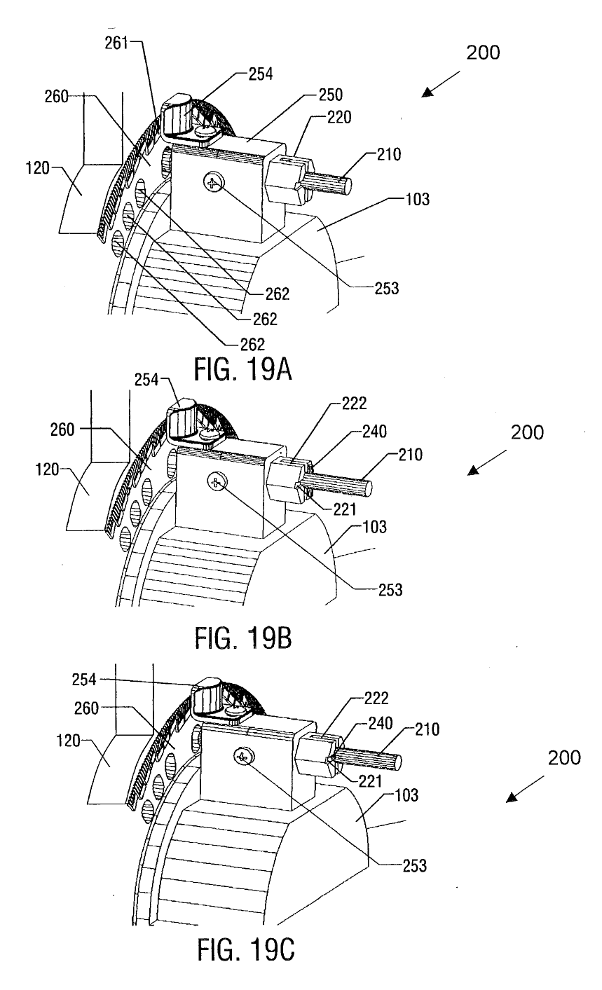

As shown in FIG. 19A, the table hub 103 of miter saw 1 further comprises bevel index housing 250 having an axial hole therethrough into which the bevel index 200 may be placed. The bevel index 200 may be secured within the bevel index housing 250 by screw 253. Pivot 120 further comprises an arcuate section 260 which may contain surface indicia 261. The arcuate section 260 may further comprise predetermined bevel index stops, such as detents or holes 262 at pre-set indexing positions. A bevel angle indicator 254 may be functionally associated with the bevel index housing 250. The spring 230 acts to bias roll pin 240 toward housing 220, preferably within slots 221 or 222.

In operation, when the roll pin 240 is located in the deeper slot 222, the tapered end of bevel index pin 210 extends through bevel index housing 250 until the tapered end of the bevel index pin 210 contacts the sides of the desired index hole 262. In this configuration, the tapered end of the spring-loaded bevel index pin 210 engages into indexing holes 262 as shown in FIG. 19A. The spring 230 acts to urge the tapered end of the bevel index pin 210 in a direction outward from the table hub housing 250.

To change the bevel angle, the user may unlock the pivot 120 from its current angle by unlocking the bevel lock 100 as described with regard to the bevel lock embodiments above. The user may then pull the exposed end of the bevel index pin 210 in a direction away from the pivot 120 until the engaging or tapered end of index pin 210 is out of the indexing hole 262. At this point, the pivot 120 is free to rotate about table hub 103. The user may rotate pivot 120 until the engaging end of index pin 210 aligns with the new desired predetermined index hole 262 and release the bevel index pin 210. When released, the spring 230 urges the roll pin 240 into the deeper slot 222. In this position, the engaging or tapered end of bevel index pin engages the desired predetermined index hole 262. The operator may then lock pivot 120 in place utilizing bevel lock 100 as described above.

Should the user wish to not utilize the bevel index 200 feature, the user may disengage the bevel index feature by pulling the exposed end of the bevel index pin 210 in a direction away from pivot 120. This overcomes the retention force of the spring 230 and removed roll pin 240 from either slot 221 or 222, as shown in FIG. 19B. The user then rotates bevel index pin 210 until the roll pin 240 aligns with the shallow slot 221. When the user releases the bevel index pin 210, the spring 230 acts to keep the roll pin 240 into contact with slot 221. Shallow slot 221 may be configured such that when the roll pin 240 is within shallow slot 221, the tapered end of bevel index pin 210 does not contact the arcuate section 260 of pivot 120, nor any predetermined index stop such as a detent or hole 262 therewithin. This will prevent the bevel index pin 210 from indexing into any of the predetermined index locations 262. Thus, with the roll pin 240 resting in the shallow slot 221, the bevel index 200 is disengaged as shown in FIG. 19C.

As shown in FIGS. 15, 16, and 17B, the bevel index 200 is constructed with the bevel index pin 210 off-center within its housing 220. This allows the user to make fine adjustments to the bevel index 200 that will align the miter saw blade to the miter saw table 7 for precise bevel angle adjustments. To do this, the user unlocks the bevel lock 100 as described above and indexes the bevel index pin 210 such that the engaging, or tapered, end of the bevel index pin is engaged into a predetermined indexing hole 262 (as described above and shown in FIG. 19A). Without locking the bevel lock 100, the operator may loosen the screw 253 that holds the bevel index 200 to the bevel index housing 250. After the screw 253 is loosened, the user can use a wrench or fingers to turn the bevel index 200 within the bevel index housing 250. Turning the bevel index 200 within the bevel index housing 250 will bias the pivot 120 clockwise or counterclockwise a predetermined amount equal to the amount of the offset from the housing 220 center-line to the bevel index ping pin 210 center-line (as shown in FIG. 16).

Once the desired bevel angle is obtained, the user may then lock the bevel lock 100 and tightens the screw 253 that secures the bevel index 200 as described above.

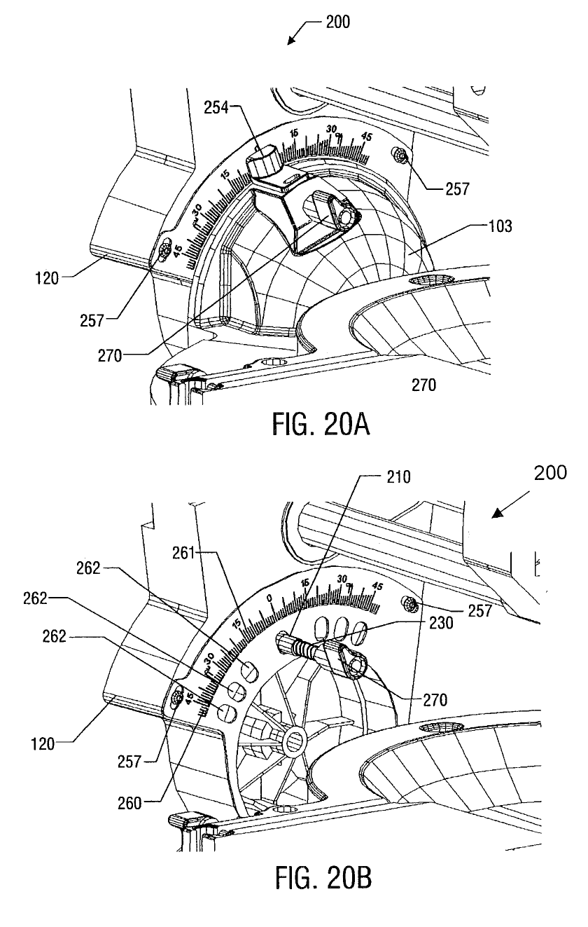

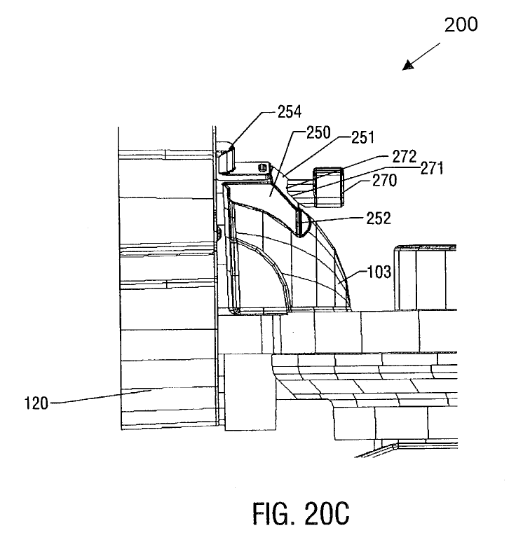

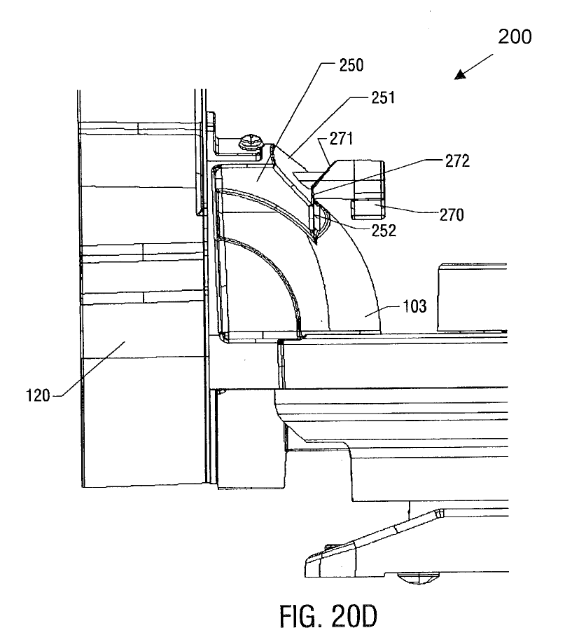

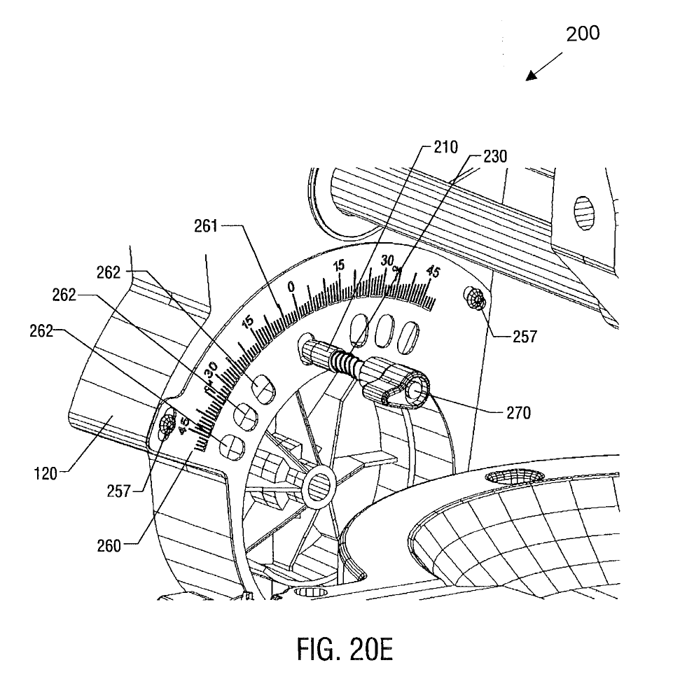

Now referring to FIGS. 20A-20E, another embodiment of the bevel index 200 is shown. This embodiment of the bevel index 200 includes bevel index pin 210 which is movably retained in a bevel index housing 250 by a spring 230 which circumscribes bevel index pin 210. The bevel index pin 210 has an engaging end which may be tapered, and a bevel index lever 270 on the other end of the bevel index pin 210. Bevel index lever 270 could be comprise a knob as opposed to a lever shape. Bevel index housing 250 is attached to table hub 103. A bevel angle indicator 254 may be functionally associated with the bevel index housing 250.

As in previous embodiments, pivot 120 further comprises an arcuate section 260 which may contain surface indicia 261. The arcuate section 260 may further compromise indexing holes 262 at preset indexing positions. The table hub 103 mates with the pivot such that the bevel index pin 210 may align with the predetermined index holes.

As shown in FIG. 20C, bevel index lever 270 may contain an angled surface 271 and a flat surface 272 on one end. Further, bevel index housing 250 may also comprise an angled surface 251 and a flat surface 252.

The bevel index 200 of this embodiment allows the user to move the bevel index pin 210 by rotating lever 270 in either the clockwise or counterclockwise direction to disengage the bevel index pin 210 from the predetermined index holes 262 in arcuate section 260 on pivot 120.

In the engaged state—i.e. when the bevel index pin 210 engages a predetermined index stop such as detent or hole 262—the angled surface 271 of the bevel index lever 270 mates with the angled surface 251 of bevel index housing 250. The spring 230 acts to bias bevel index pin 210 toward the arcuate section 260, which in turn acts to bias angled bevel index lever 270 toward bevel index housing 250. In operation, the operator may rotate the bevel index lever 270 in either direction. As the bevel index lever 270 is rotated, the two angled surfaces 251 and 271 act as a cam that pulls engaging end of the bevel index pin 210 out of the predetermined index stops such as detents or holes 262 in the arcuate section 260 of pivot 120. When in the disengaged state—i.e. when the engaging end of the bevel index pin 210 is not engaging a predetermined index stop such as detent or hole 262—the pivot is free to rotate about the hub housing 103. It should be noted that the predetermined index stops could be comprised of separate components attached to the pivot as opposed to the detents or holes 262 in the arcuate section 260 of pivot 120. For instance, the predetermined index stops may be comprised of holes formed in a plate mounted to the arcuate section 260 of pivot 120.

Once the pivot is rotated to a new, desired bevel angle corresponding to a predetermined index hole, the user may release the bevel index lever 270. The spring 230 acts to pull the bevel index lever 270 toward housing 250, which concomitantly forces the engaging end of bevel index pin 210 into engagement with the new predetermined index hole. The user may use the bevel lock 100 described above to lock the pivot 120 in place.

In this embodiment, the bevel index 200 can be overridden so that the engaging end of the bevel index pin 210 cannot not engage the predetermined index holes 262. This is done by rotating the bevel index lever 270 so that the flat portion 272 of the bevel index lever 270 rests on the flat surface 252 of the table hub 250. With these two flat surfaces 252 and 272 mating, the spring 230 cannot pull the bevel index pin 210 back down the angled surfaces 251 and 271, thus preventing the engaging end of the bevel index pin 210 from engaging a predetermined index hole 262, as shown in FIG. 20D.

To fine tune the bevel angles in this embodiment, the arcuate section 260 may be mounted to pivot 120 via bevel adjustment screws 257. To provide for precise bevel angle adjustment, the arcuate section 260 may further comprise angled slots through which screw 257 may pass, as shown in FIGS. 20A, 20B, and 20E. Such a procedure may be utilized, for example, when the miter saw 1 is calibrated for given bevel angles, e.g. to square the blade to the table. Adjustment of the bevel angle is achieved by loosening the bevel adjustment screws 257 and rotating the pivot assembly 120 to the desired bevel position needed to square the blade 17 to the table 7. When the adjustment is complete the bevel adjustment screws 257 are tightened to keep the arcuate section 260 in the desired position on the pivot 120.

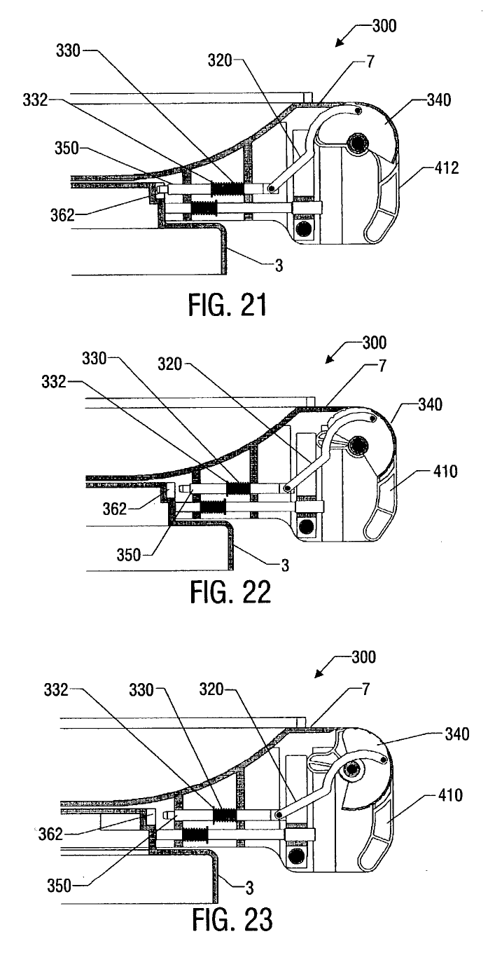

Shown in FIGS. 21-23 are embodiments of a miter index 300. The miter index 300 advantageously provides positive indexing of the table 7 at the desired predetermined positions. Additionally, the miter index 300 may be disengaged should the user not desire to use the miter index 300. As will be seen in the following description, the miter index 300 disclosed herein is located on the miter saw 1 such that it may be utilized by either left-handed or right-handed persons with equal ease, i.e. it is ambidextrous.

The miter index 300 may be comprised of a miter index pin 350, a connecting link 320, a spring 330, and a miter index actuator such as a miter index thumb wheel 340. Of course, the thumb wheel could be replaced with any number of devices, such as a lever, known to one of ordinary skill in the art having the benefit of this, disclosure. Miter saw base 3 upon which table 7 is rotatably mounted may comprise a positive-stop mechanism such as a plurality predetermined index stops such as of detents or holes spaced along the base to correspond to predetermined miter index angles (e.g. 0, 15°, 22.50°, 31⅝° for crown molding, 45°, and 60°). Miter index pin 350 is movably connected to the table 7 such that an engaging end, which may be tapered, of the miter index pin may align with the predetermined index detents or holes 362. Spring 330 may circumscribe miter index pin 350. The miter index pin 350 may further comprise a retaining ring 332 which abuts spring. The miter index pin 350 is further attached to a miter index thumb wheel 340 via a connecting link 320. The miter index thumb wheel is rotatably mounted to the table 7.

Generally, the miter index 300 will be in its “engaged” position as shown in FIG. 21: i.e. the spring 330 urges the miter index pin 350 into engagement with any one of the plurality of predetermined detents or holes 362. Thus, the table 7 is set to a miter angle corresponding to the predetermined index detents or holes 362.

Should an operator wish to change the miter angle from one index miter angle to another, the miter index 300 may be operated as follows. First, the table 7 is unlocked. For example, the process of unlocking miter lock 400 is described hereinafter. Next the miter index thumb wheel 340 is rotated such that the connecting link 320 overcomes the biasing force of spring 330 to disengage the miter index pin 350 from the predetermined index hole or detent 362. The retaining ring 332 acts to compress spring 330 against the table 7 as shown in FIG. 22. At this point, table 7 is free to rotate about base 3 at any given miter angle, as shown in FIG. 22. The operator may then rotate the table 7 to the predetermined index detent or hole 362 corresponding to the desired miter angle, and may release the miter index thumb wheel 340. The spring 330 urges the miter index pin 350 to engage the predetermined index detent or hole 362 to stop the table at this given miter angle. A miter lock may then be used to lock the table 7 at the given miter angle.

If it is desired to rotate the table 7 without having to hold the thumb wheel 340 in the downward position while selecting the desired miter angle of the table 7 (or if it is desired to deactivate the miter index 300 from being operable for a given time), the user can rotate the thumb wheel 340 fully downward. This action causes the connecting link 320 to travel to an “over-centered” position of the thumb wheel 340, as shown in FIG. 23. The spring 330 connected to the miter index pin 350 will now be acting in such a manner that the miter index pin 350 will pull on the connecting link 320 in the over-centered position to keep the thumb wheel 340 in this position. The miter index pin 350 will not protrude into the predetermined index detents or holes 362 in the base 3 until the user returns the thumb wheel 340 upward.

Deactivating the miter index 300 may be useful when the desired miter angle is a small increment past one of the predetermined index detent or hole positions. (e.g., preset detent angle is 45° and a 45.25° angle is desired).

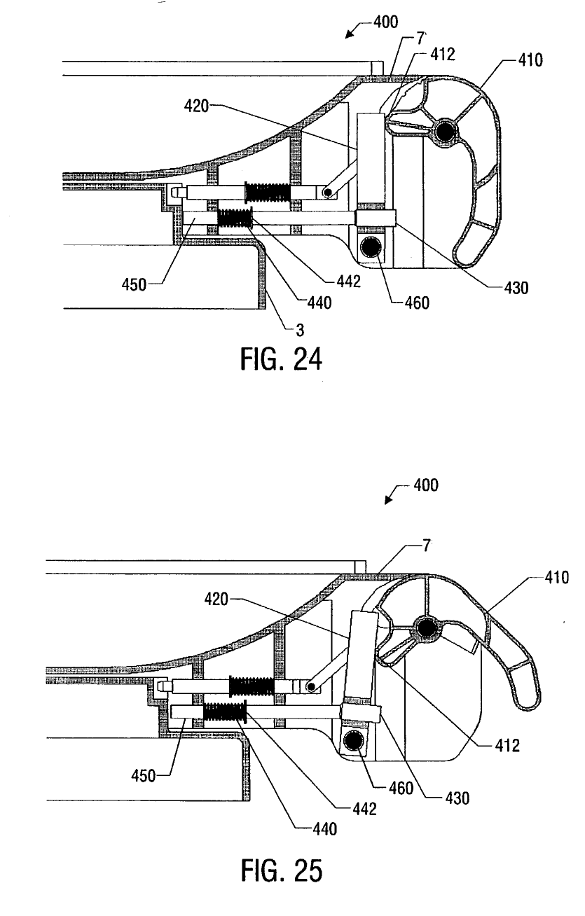

Now referring to FIGS. 24-27, embodiments of a miter lock 400 is shown. The miter lock 400 may provide positive locking of the table 7 to the base 3 at any miter angle. In one embodiment, the miter lock 400 includes a miter lock actuator such as miter lock lever 410 that may be pivotally mounted to table 7. A cammed contacting surface 412 on the miter lock lever 410 is capable of contacting a miter lock plate 420. Alternatively, the cammed contacting surface 412 on the miter lock lever 410 may contact one end of miter lock pin 450. The miter lock plate 420 may be pivotally mounted to the table 7 about pivot point 460. One end of a miter lock pin 450 may contact the miter lock plate 420 via, e.g., a set screw 430 in the miter lock plate 420. The miter lock pin 450 is circumscribed by spring 440. The miter lock pin 450 may comprise a retaining ring 442 which contacts spring 440. The other end of the miter lock pin 450 may be urged away from contact with the base 3 by spring 440.

The miter lock pin 450 being urged into contact with the base 3 by the set screw 430 mounted in miter lock plate 420—which has a force applied by the cammed surface 4121 on the miter lock lever 410—to lock the table 7 at a given miter angle.

Generally, the miter lock 400 is in the locked position shown in FIG. 24. In the locked position, cammed contact surface 412 on the miter lock lever 410 pushes on the miter lock plate 420 as the miter lock lever 410 is rotated down toward the locked position. A the miter lock plate 420 is pushed toward the base 3 and pivots about pivot 460, the set screw 430 in the miter lock plate 420 pushes the miter lock pin 450 into the base 3, which causes the table 7 and base 3 to lock together. In this configuration, the retaining ring 442 acts to compress spring 440 against table 7. The clamping force of the lock pin can be adjusted by turning the set screw 430 in or out until the desired clamping force has been met.

To unlock the table 7, a user may lift upwardly on the miter lock lever 410 as shown in FIG. 25. Spring 440 (which is in compression between the retaining ring 442 on the miter lock pin 450 and the table 7) biases miter lock pin 450 away from base 3, and thus forces miter lock plate 420 to rotate about its pivot 460. With the table 7 in the unlocked position, the user may rotate the table freely to the next desired miter angle.

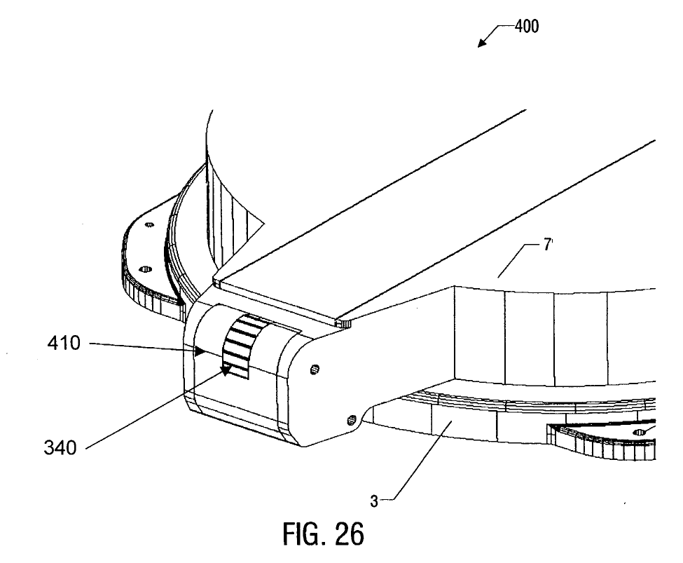

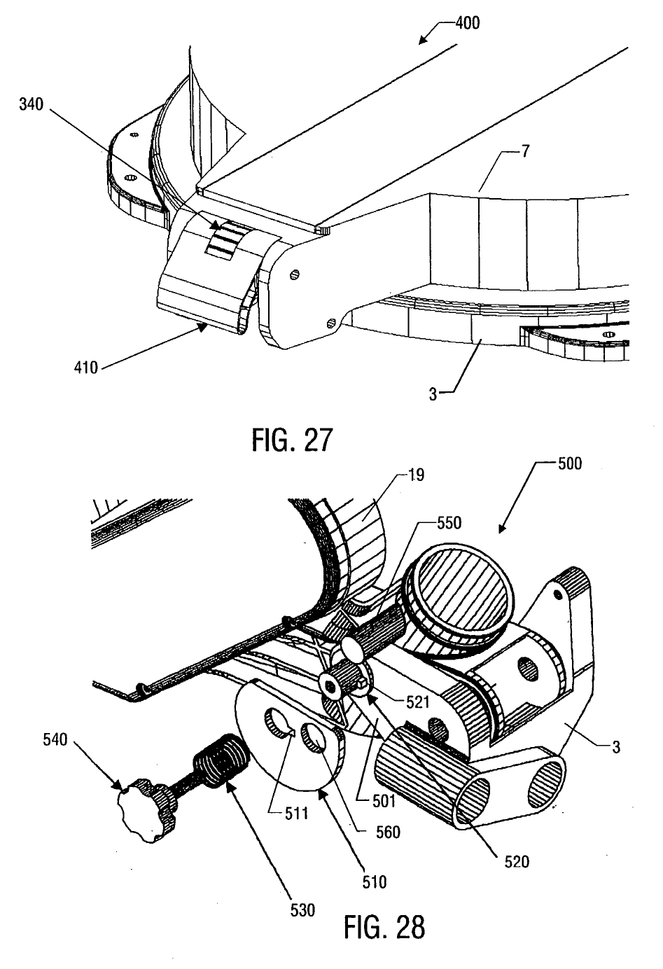

It should be noted that embodiments of both the miter lock 300 and the miter index 400 were shown in FIGS. 21-25. Additionally, the miter index thumb wheel 340 and the miter lever lock 410 are shown in FIGS. 26 and 27. In FIG. 26, the miter lock lever 410 is in its locked position, while miter lock lever 410 is shown in its unlocked position in FIG. 27 in these embodiments.

Referring to FIGS. 28-34, embodiments of a down stop 500 for a miter saw 1 are shown. In some instances, it is desired to make cuts with a slide miter saw at a desired depth that do not go all the way through the workpiece. Thus, embodiments of a downstop 500 for a miter saw 1 is provided. Some embodiments of the downstop 500 may include a stop 550 on the upper housing 19 and a knob 540 attached to an upper pivot 501 of the miter saw 1. The knob 540 may be circumscribed by a spring 530 and may rotatably attach an eccentric 510 to the upper pivot 501 by way of flange bushing 520. Flange bushing 520, which is rotatably mounted to the upper pivot 501, may have a key 521 to mate with a key-way 511 in the eccentric 510 as described hereinafter. An exploded view of the knob 540, spring 530, eccentric 510, flange bushing 520 on upper pivot 501, and stop 550 on upper housing 19 are shown in FIG. 28.

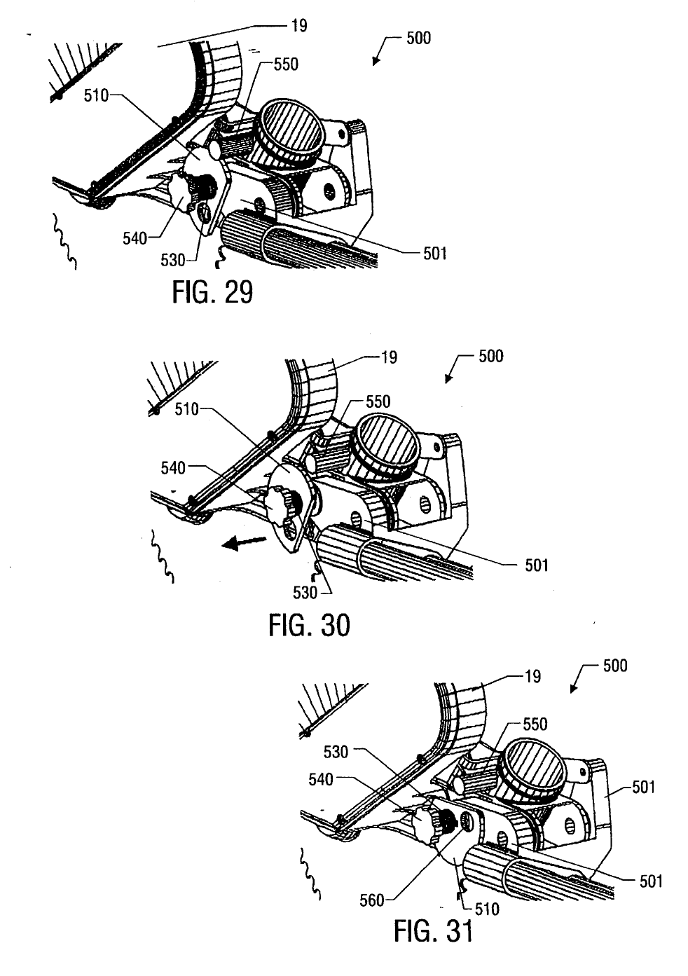

In operation, as the motor 21 and upper housing 19 are lowered, the stop 550 on the upper housing 19 contacts the eccentric 510. Once contact is made with the eccentric 510, any additional downward motion of the upper housing 19 is not possible, as shown in FIG. 29. The user can adjust the depth at which the downward motion is limited by loosening the knob 540 and turning the eccentric 510 in a direction that will allow either more or less depth of cut. For instance, the down stop 500 is shown allowing a blade height of H1 in FIG. 33, and a blade height of H2 in FIG. 34.

As the key 521 on the flange bushing 520 is mated with the key-way 511 on the eccentric 510, rotating the eccentric 510 also rotates flange bushing 520 on upper pivot 501. When the user has turned the eccentric 510 from its location that corresponds to the desired depth of cut, the knob 540 may then be tightened which will keep the flanged bushing 520 at that location which corresponds to the desired depth of cut. Should the user desire to make a through cut but not want to lose the setting that has been previously set, the user may apply an outward force on the eccentric 5 1 0 to overcome the force of the spring 530 to disengage the key-way 511 of the eccentric 510 from the key 521 on the flanged bushing 520. With the key 521 no longer mating with the key-way 511, the user may then rotate the eccentric 510 and release the outward force on the eccentric 510.

As stated above, the key-way 511 on the eccentric 510 is mated with the key 521 on the flange 520. Pulling outwardly on the eccentric 510 to overcome the force of the spring 530 will disengage the key 521 on the flange bushing 520 from the key-way 511 on the eccentric 510 as shown in FIG. 30. Thus, the flange bushing 520 remains at the predetermined setting corresponding to a desired depth of cut, provided knob 540 remains tightened. The eccentric may now be disengaged so that the saw head on the upper housing 19 may be lowered to the full depth as shown in FIG. 31.

When it is desired to return to the previous predetermined non-through cut setting, an outward force may be applied to the eccentric 510 to overcome the force of the spring 530. With this outward force applied, the eccentric 510 may be rotated such that its key-way 511 mates with key 521 on flange bushing 520. The spring 530 acts to push the eccentric 510 over the key-way 511 so that the setting is secure. To set the miter saw to a new depth of cut, knob 540 may be loosened. Provided no outward force is applied to the eccentric, the key 521 on the flange 520 remains mating with the key-way on the eccentric. Thus, as the user rotates the eccentric 510 to a location corresponding to a new depth of cut (an operation described above), the flange 520 also rotates. Once the new depth of cut is selected, the knob 540 may be tightened.

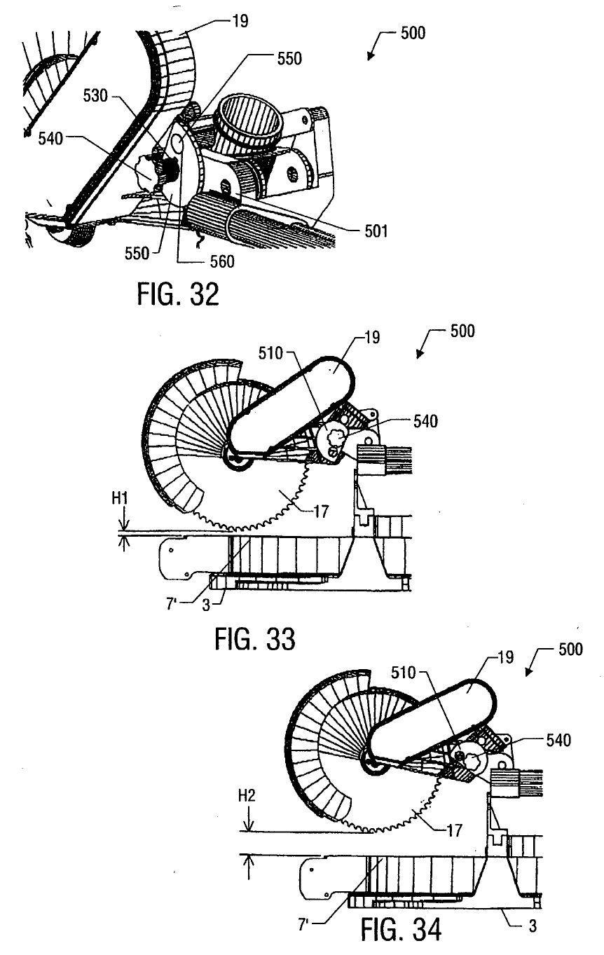

Additionally, eccentric 510 may comprise a hole 560 which aligns with the stop 550 on the upper housing 19, such that when the miter saw I is being transported, the upper housing 19 may be locked to the upper pivot 501 by rotating the eccentric 510 such that the stop 550 engages the hole 560 in the eccentric 510, as shown in FIG. 32.

Referring back to FIG. 5, an embodiment of a dust collecting apparatus for a miter saw is shown.

The improved dust collecting apparatus comprises a bag 610 to collect sawdust and a framework 620 to support the bag 610. The framework 620 attaches at the front of the bag 610 and at the rear of the bag 610. This framework 620 secures the bag 610 to the miter saw 1 as well as maintains the shape of the bag 610.

The rear-supporting framework will attach around the tubes and to the tube cap while the front supporting framework may be attached around the tubes and the pivot 120. The framework 620 assists to keep the bag 610 above the pivot 120 and allows the bag 610 to move forward and backward with the upper housing 19.

The back of the bag has a flexible neck 612 that allows the bag 610 to remain attached to the dust chute 613 as the upper housing 19 is lowered and raised. This dust bag 610 is not prone to falling off as the bag 610 fills. Nor is the dust bag 610 prone to getting pinched off as the upper housing 19 is lowered and raised due to the supporting framework 620.

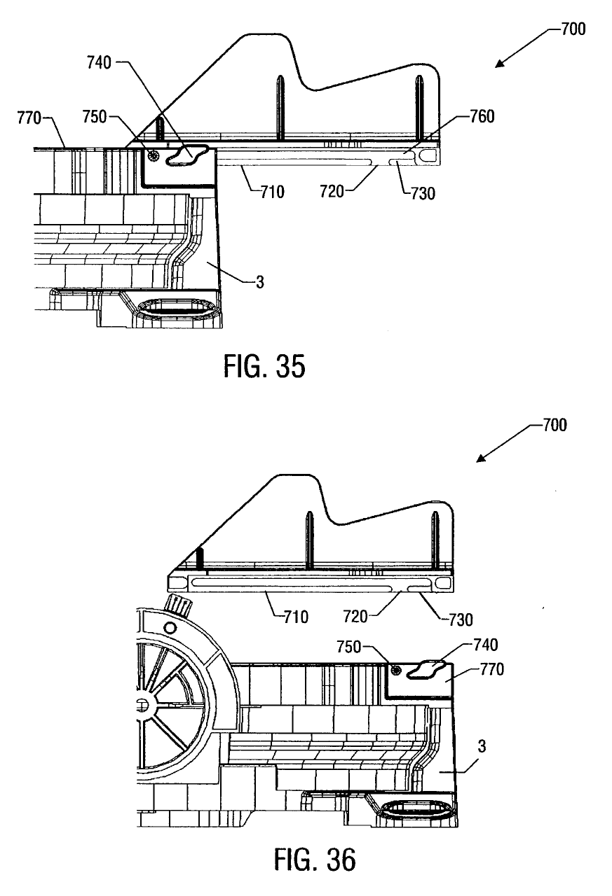

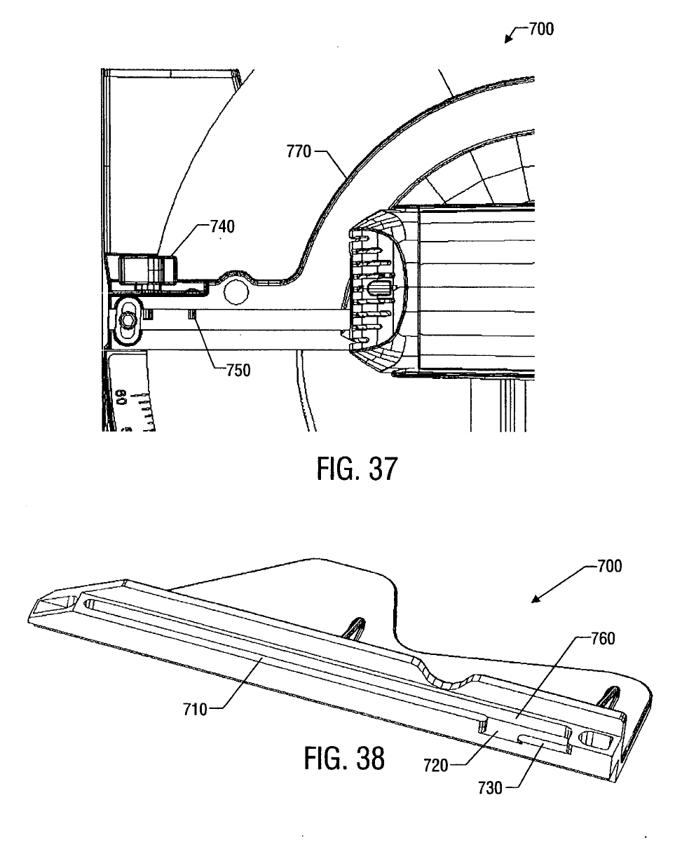

Referring to FIGS. 35-38, an improved sliding fence 700 for a miter saw is shown. In one embodiment shown in FIG. 35, a lower fence 770 may be fixedly attached to base 3. The lower fence 770 has a groove into which the sliding fence 700 may be inserted perpendicularly. The sliding fence 700 has a tongue 760 which may be inserted into the groove of the lower fence 770. Below the tongue of the sliding fence 700 is a rib 710, and opening 720, and a shortened rib 730. Also located on the lower fence 770 is a fence clamp knob 740 and a retainer screw 750. Generally, the sliding fence 700 is free to slide within the groove of the lower fence 770 to a desired position. Once the sliding fence 700 is in a desired position, the fence clamp knob 740 may be rotated to secure the sliding fence 700 at that location on the lower fence 770.

The retainer screw 750 in the lower fence 770 acts in conjunction with the rib 710 to prevent the sliding fence 700 from inadvertent removal from the lower fence 770. However, should it be desired to remove the sliding fence 700 from the lower fence 770, the fence clamp knob 740 may be rotated to allow the sliding fence 700 to slide within the groove in lower fence 770. The open portion 720 of the sliding fence 700 is aligned with the retainer screw 750, the sliding fence may be lifted off the lower fence 770 as shown in FIG. 36 without the need to remove the retaining screw 750 or the fence clamp knob 740

The shortened rib 730 prevents the sliding fence 700 from being lifted off the lower fence 770 when the fence clamp knob 740 is loosened to make adjustments to the sliding fence 700. Shortened rib 730 allows the sliding fence 700 to be removed from the lower fence 770—without requiring the removal of the fence clamp knob 740—when the opening 720 is aligned with the retaining screw 750 and when the fence clamp knob 740 is loosened a predetermined number of turns.

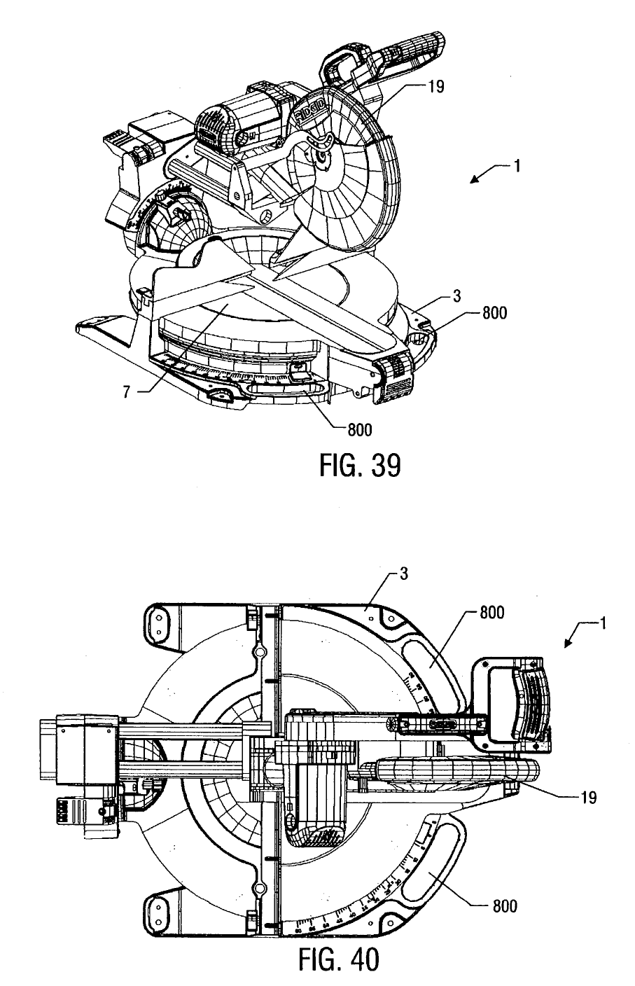

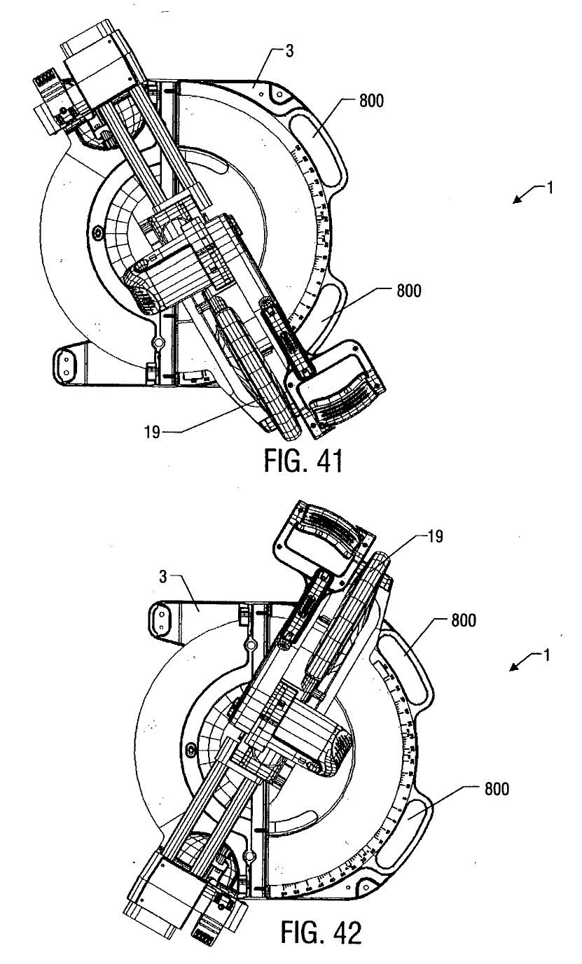

Referring to FIGS. 39-42, embodiments of an improved miter saw 1 is shown having carry handles 800 formed into the base 3 of the miter saw 1 for convenience and ease of transporting the miter saw 1. In some embodiments, two carry handles are shown, although any number of handles could be utilized. Further, both carry handles 800 are accessible when the saw is in the 00, 60° left, and 60° right miter positions in some embodiments. Again, the carry handles 800 could be formed into the base 3 at any angle on the periphery of the base 3. Finally, although the handles are shown formed into the base 3, the handles could be external and attached to the base, not formed from the base. The carry handles 800 allow the saw to be close to the users' body while carrying the miter saw 1 for ease and safety of use.

Although various embodiments have been shown and described, the invention is not so limited and will be understood to include all such modifications and variations as would be apparent to one skilled in the art.

What is claimed is:

1. A bevel lock for use with a miter saw, the miter saw having table rotatably mounted to a base, and an upper housing to which a blade is rotatably mounted, the upper housing being attached to a pivot to angularly displace the blade such that the blade forms a given bevel angle with the table, the bevel lock comprising:
a bevel lock lever positional to a first and a second position on the pivot; and
a lever arm functionally associated with the bevel lock lever such that when the bevel lock lever is in the first position, the pivot is free to rotate about the table hub, and when the bevel lock lever is in the second position, the table hub is locked to the pivot about the table hub with the blade forming a given bevel angle with the table.

2. The bevel lock of claim 1 in which the lever arm engages the table hub to lock the pivot about the table hub, when the bevel lock lever is in the second position.

3. The bevel lock of claim 1 in which the lever arm is pivotally attached to the pivot.

4. The bevel lock of claim 1 in which the pivot is pivotally attachable to a table hub on the table.

5. The bevel lock of claim 4 in which the lever arm has a contacting surface that engages the table hub when the bevel lock lever is in the second position.

6. The bevel lock of claim 1 in which the bevel lock lever contacts one end of a plunger pin, the other end of the plunger pin contacting the lever arm.

7. The bevel lock of claim 6 in which the plunger pin is circumscribed by a biasing means.

8. The bevel lock of claim 7 in which the biasing means is a spring.

9. The bevel lock of claim 6 in which the plunger pin contacts the lever arm at a retaining means such that when the bevel lock lever is moved from the first to the second position, the lever arm rotates to engage the table hub to lock the blade at a given bevel angle with respect to the table.

10. The bevel lock of claim 9 in which the retaining means comprises a spring retainer.

11. The bevel lock of claim 1 in which the pivot has surface indicia corresponding to bevel angles.

12. The bevel lock of claim 1 in which the bevel lock lever has a cammed surface.

13. The bevel lock of claim 6 in which the plunger pin contacts the lever arm at a free end of the lever arm, such that when the bevel lock lever is moved from the first to the second position, the lever arm rotates to contact the table hub to lock the pivot about the table hub with the blade forming a given bevel angle with the table.

14. The bevel lock of claim 13 in which the lever arm is integrally formed.

15. The bevel lock of claim 6 further comprising a lock nut adjustably attached to the end of the plunger pin substantially adjacent the lever arm.

16. The bevel lock of claim 15 in which the lever arm is pivotally attached to the pivot by a shoulder bolt.

17. The bevel lock assembly of claim 15 in which the bevel lock lever has a cammed surface, a first end of the plunger pin contacting a cammed surface of the bevel lock lever and a second end of the plunger pin contacting a free end of the lever arm such that when the bevel lock lever is moved from the first position to the second position, the cammed surface moves the plunger pin toward the lever arm to engage the table hub to lock the blade at a given bevel angle with respect to the table.

18. A bevel lock for use with a miter saw, the miter saw having a table rotatably mounted to a base, and an upper housing to which a blade is rotatably mounted, the upper housing being attached to a pivot to angularly displace the blade such that the blade forms a given bevel angle with the table, the bevel lock comprising:
a bevel lock actuator positionable to a first and a second position on the pivot; and
a table contact functionally associated with the bevel lock actuator such that when the bevel lock actuator is in the first position, the pivot is free to rotate about the table, and when the bevel lock actuator is in the second position, the table contact engages the table hub to lock the pivot about the table hub with the blade forming a given bevel angle with the table.

19. The bevel lock of claim 18 in which the bevel lock actuator is a lock knob and the table contact is a plunger.

20. The bevel lock of claim 19 in which the knob contacts one end of a plunger pin.

21. The bevel lock of claim 20 in which the plunger pin is circumscribed by a spring to bias the plunger pin toward the table hub.

22. The bevel lock of claim 21 in which another end of the plunger pin is integrally formed with the plunger, such that when the lock knob is in the second position, the plunger engages the table hub to lock the pivot on the table.

23. The bevel lock of claim 21 in which another end of the plunger pin contacts a cantilevered arm pivotally attached to the pivot, such that when the lock knob is in the second position, the cantilevered arm depresses the plunger to engage the table hub to lock the pivot on the base.

24. The bevel lock of claim 21 in which the pivot has surface indicia corresponding to bevel angles.

25. The bevel lock of claim 24 in which the bevel lock actuator is a bevel lock lever and the table contact is a lever arm.

26. A bevel index for use with a miter saw, the miter saw having an upper housing to which a blade is rotatably mounted, the upper housing being attached to a pivot to angularly displace the blade such that the blade forms a given bevel angle with the table, the bevel index comprising:
a bevel index housing functionally associated with the table of the miter saw; and
a bevel index pin axially movable within a pin housing which is functionally associated with the bevel index housing such that the bevel index pin is engageable with one of a plurality of predetermined index stops in the pivot to set blade of the miter saw at a predetermined bevel angle with respect to the table.

27. The bevel index of claim 26 in which the bevel index pin is positionable to a first and a second position within the pin housing, the bevel index pin engaging one of the plurality of predetermined index stops when the bevel index pin is in the first position and the bevel index pin prevented from engaging the plurality of predetermined index stops when the bevel index pin is in the second position.

28. The bevel index of claim 27 in which the predetermined index stops are detents in an arcuate section of the pivot.

29. The bevel index of claim 27 in which the predetermined index stops are holes in an arcuate section of the pivot.

30. The bevel index of claim 29 in which the holes are spaced radially along the arcuate section of the pivot.

31. The bevel index of claim 30 in which the holes are located on the pivot such that the holes are associated with bevel angles of 45 degrees, 33⅞ degrees, 22½ degrees, and zero degrees.

32. The bevel index of claim 27 in which the predetermined index stops are holes in an indexing plate attached to the pivot.

33. The bevel index of claim 27 in which the arcuate section of the pivot includes surface indicia.

34. The bevel index of claim 33 in which a bevel angle indicator is mountable to the bevel index housing such that the bevel angle indicator aligns with the surface indicia to indicate the bevel angle.

35. The bevel index of claim 27 in which the bevel index pin has a tapered end that is engageable with the predetermined index stops.

36. The bevel index of 27 in further comprising a spring to urge the bevel index pin toward the arcuate section of the pivot.

37. The bevel index of claim 27 in further comprising:
a first slot and a second slot in the pin housing; and
a pin in the bevel index pin such that when the pin is in the first slot, the bevel index pin is in the first position, and when the pin is placed in the second slot, the bevel index pin is in the second position.

38. The bevel index of claim 37 in which the first and second slots are perpendicular to each other.

39. The bevel index of claim 27 wherein a longitudinal axis of the bevel index pin is offset from a longitudinal axis of the bevel index housing.

40. The bevel index of 39 wherein the bevel index pin housing is releaseably secured within the bevel index housing, such that the bevel index pin housing is rotatable within bevel index housing to allow for precise adjustment of the bevel angle.

41. The bevel index of 40 in which the index pin housing is releaseably secured within the bevel index housing by a screw.

42. The bevel index of claim 27 in which the bevel index pin has a lever on an end.

43. The bevel index of claim 42 in which the lever has an angled surface and a flat surface.

44. The bevel index of claim 43 in which the bevel index housing has an angled surface and a flat surface.

45. The bevel index of claim 44 in which the angled surface of the lever mates with the angled surface of the bevel index housing when the bevel index pin is in the first position.

46. The bevel index of claim 45 in which the flat surface of the lever mates with the flat surface of the bevel index housing when the bevel index pin is in the second position.

47. The bevel index of claim 46 in which the bevel index pin is moveable about an axis by rotating the lever from a first location in which the angled surface of the lever mates with the angled surface of the bevel index housing to a second location in which the flat surface of the lever mates with the flat surface of the bevel index housing.

48. The bevel index of claim 47 in which the arcuate section of the pivot further comprises a plate which is movably attachable to the pivot such that the bevel angle may be adjusted by moving the arcuate section with respect to the pivot.

49. The bevel index of claim 48 in which the arcuate section comprises slots for movably attaching the arcuate section to the pivot. 50. A miter index for use with a miter saw, the miter saw having table rotatable at given miter angles on a base and an upper housing to which a blade is rotatably mounted, the miter index comprising:
a miter index actuator functionally associated with the table;
a miter index pin axially movable within the table such that the miter index pin is engageable with one of a plurality of predetermined miter index stops in the base to set the miter saw at a predetermined miter angle; and
a connecting link to connect the miter actuator to the miter index pin.

51. The miter index of claim 50 in which the miter index actuator is rotatably mountable to the table.

52. The miter index of claim 51 in which the miter index actuator is a thumb wheel.

53. The miter index of claim 50 in which the miter index pin is circumscribed by a spring functionally associated with the table and contacting a retaining ring on the miter index pin to bias the miter index pin in a direction toward the plurality of predetermined miter index stops in the base.

54. The miter index of claim 50 in which the plurality of predetermined miter index stops are placed at locations on the base associated with miter angles of 0°, 15°, 22.5,°31⅝°, 45°, and 60°.

55. The miter index of claim 50 in which the miter index pin is positionable to a first position and a second position within the base, the miter index engaging one of the plurality of predetermined miter index stops when in a first position and the miter index pin being prevented from engaging the plurality of predetermined miter index stops when the miter index pin is in the second position.

56. The miter index of claim 55 in which the miter index pin is positionable to the second position by fully rotating the actuator, the connecting link being in an over-centered position such that the spring biases the connecting link in the over-centered position.

57. A miter lock for use with a miter saw, the miter saw having table rotatable at given miter angles on a base and an upper housing to which a blade is rotatably mounted, the miter lock comprising:
a miter lock actuator functionally associated with table of the miter saw; and
a miter lock pin axially movable within the table such that the miter lock pin is engageable with the base to lock the miter saw at a predetermined miter angle.

58. The miter lock of claim 57 further comprising and a miter lock plate to connect the miter lock actuator to the miter lock pin. 59. The miter lock of claim 8 in which the miter lock actuator is a lever.

60. The miter lock of claim 58 in which the miter lock actuator is rotatably attachable to the table.

61. The miter lock of claim 58 in which the miter lock plate is pivotally mounted to the table.

62. The miter lock of claim 58 in which a spring is functionally associated with the table to bias the miter lock pin in a direction away from the base.

63. The miter lock of claim 62 in which the spring circumscribes the miter lock pin.

64. The miter lock of claim 58 in which the miter lock pin is positionable in a first position in which the miter lock pin is out of contact with the base thus allowing the table to freely rotate, and a second position in which the miter lock pin contacts the base to lock the miter saw at the predetermined miter angle.

65. The miter lock of claim 64 in which when the miter lock lever is rotated, the miter lock pin moves from the first to the second position.

66. The miter lock of claim 65 in which the miter lock lever has a contact surface to contact the miter lock plate to cause the miter lock plate to rotate when the miter lock lever is rotated, to cause the miter lock pin to move from the first to the second position.

67. The miter lock of claim 66 in which the contact surface is cammed.

68. The miter lock of claim 67 in which one end of the miter lock pin is adjustably connected to the miter lock plate by a miter lock adjustment.

69. The miter lock of claim 68 in which the miter lock adjustment is a set screw.

70. The miter lock of claim 69 in which the spring contacts a retaining ring on the miter lock pin to bias the miter lock pin in a direction away from the base.

71. A down stop for use with a miter saw, the miter saw having an upper housing to which a blade is rotatably mounted and a table, the down stop comprising:
a stop mountable to the upper housing;
a flange bushing adjustably mountable to an upper pivot on the table; and
an eccentric disengageably mounted to the flange bushing by a knob, the eccentric adapted to contact the stop when the blade is lowered to a desired depth of cut.

72. The down stop of claim 68 in which the knob is circumscribed by a spring.

73. The down stop of claim 72 in which the spring biases the eccentric toward the flange.

74. The down stop of claim 71 in which the flange bushing comprises a key which mates with a key-way in the eccentric such that when the eccentric is rotated, the flange bushing is concomitantly rotated.

75. The down stop of claim 74 in which the eccentric may be rotated to a first position corresponding to a first predetermined depth of cut.

76. The down stop of claim 75 in which the eccentric may be rotated to a second position corresponding to a second predetermined depth of cut.

77. The down stop of claim 75 in which the eccentric may be rotated to a plurality of positions corresponding to a plurality of depths of cut.

78. The down stop of claim 71 in which the eccentric is disengagable to allow the miter saw to be lowered to full depth.

79. The down stop of claim 76 in which the eccentric comprises a hole alignable to engage the downstop to lock the upper housing to the base.

80. The down stop of claim 71 in which the key-way on the eccentric is selectively disengageable from the key on the flange bushing to allow the eccentric to adjust for full depth of cut.

81. A dust collector for the miter saw of claim 18 or 37 further comprising:
a bag having a front, a rear, and a flexible neck; and
a framework supporting the front and the rear of the bag, the flexible neck being attachable to a dust chute on the upper housing.

82. A sliding fence for use with a miter saw, the miter saw having an upper housing to which a blade is rotatably mounted and a base, the sliding fence comprising:
a tongue slidably attachable into a groove on a lower fence on the base; and
a rib acting in conjunction with a retaining screw on the lower fence to secure the tongue of the sliding fence within the groove to allow sliding movement of the fence, the rib having an opening such that when the opening is aligned with the retaining screw, the sliding fence may be removed.

83. The sliding fence of claim 82 further comprising a fence clamp knob rotatably mounted to the lower fence to secure the sliding fence at a desired location on the lower fence.

84. A carry handle for use in conjunction with the miter saw of claim 18 or claim 37 in which at least one carry handle is integrally formed into the base at a given angle. 85.
The carry handles of claim 84 in which a first carry handle is integrally formed in base on one side of the pivot and a second carry handle is integrally formed in the base on the other side of the pivot.

86. A compound miter saw for cutting adapted to cut a workpiece at a miter angle and at a bevel angle, comprising:
a table rotatably mounted to a base;
an upper housing to which a blade is rotatably mounted, the upper housing being attached to a pivot to angularly displace the blade such that the blade forms a given bevel angle with the table;
a bevel lock having a bevel lock lever positional to a first and a second position on the pivot;
a lever arm functionally associated with the bevel lock lever such that when the bevel lock lever is in the first position, the pivot is free to rotate about the table hub, and when the bevel lock lever is in the second position, the lever arm engages the table hub to lock the pivot about the table hub with the blade forming a given bevel angle with the table;
a bevel index housing functionally associated with the base of the miter saw;
a bevel index pin axially movable within a pin housing which is functionally associated with the bevel index housing such that the bevel index pin is engageable with one of a plurality of predetermined index stops in the pivot to set the miter saw at a predetermined bevel angle;
a miter index having a miter index actuator functionally associated with the table;
a miter index pin axially movable within the table such that the miter index pin is engageable with one of a plurality of predetermined miter index stops in the base to set the miter saw at a predetermined miter angle;
a connecting link to connect the miter actuator to the miter index pin;
a miter lock having a miter lock actuator functionally associated with table of the miter saw;
a miter lock pin axially movable within the table such that the miter lock pin is engageable with the base to lock the miter saw at a predetermined miter angle;
a miter lock plate to connect the miter lock actuator to the miter lock pin;
a down stop having a stop mountable to the upper housing;
a flange bushing adjustably mountable to an upper pivot on the table;
an eccentric disengageably mounted to the flange bushing by a knob, the eccentric adapted to contact the stop when the blade is lowered to a desired depth of cut;
a dust collector having a bag with a front, a rear, and a flexible neck;
a framework supporting the front and the rear of the bag, the flexible neck being attachable to a dust chute on the upper housing;
a sliding fence having a tongue slidably attachable into a groove on a lower fence on the base;
a rib acting in conjunction with a retaining screw on the lower fence to secure the tongue of the sliding fence within the groove to allow sliding movement of fence, the rib having an opening such that when the opening is aligned with the retaining screw, the sliding fence may be removed; and
a carry handle in which at least one carry handle are integrally formed into the base of the miter saw.
